(19) United States
(12) Patent Application Publication
(10) Pub. No.: US 2025/0217524 A1
(43) Pub. Date: Jul. 3, 2025

(54) CABLE ASSEMBLY DESIGN TOOL WITH FIBER UTILIZATION COUNTER

(71) Applicant: CORNING RESEARCH & DEVELOPMENT CORPORATION, CORNING, NY (US)

(72) Inventors: TIMOTHY BEAUCHAMP, SAINT-LAURENT (CA); ANDERSON BORDIM, MONTREAL (CA); GUILLAUME LONGTIN, LAVAL (CA); OWEN MACDONALD, POINTE-CLAIRE (CA)

(21) Appl. No.: 18/853,735

(22) PCT Filed: Apr. 4, 2022
(86) PCT No.: PCT/US2022/023290

§ 371 Date: Oct. 3, 2024

(51) Int. Cl. G06F 30/12; G06F 113/16

(52) U.S. Cl. CPC G06F 30/12; G06F 2113/16

(57) ABSTRACT

A non-transitory computer readable medium having stored thereon a plurality of computer-executable instructions is provided. The instructions, when executed by processing circuitry, cause the processing circuitry to determine an available fiber count. The user-customized cable includes a primary cable (118A) and subunit cables (110B, 110B′) including end fibers. The available fiber count is a theoretical number of end fibers available in the primary cable. Instructions cause processing circuitry to receive user inputs indicating addition or subtraction of a subunit cable (110B) on a first or second end of the user-customized cable. Instructions cause processing circuitry to determine a current number of end fibers in a user-customized cable and determine whether the available fiber count is less than the current number of end fibers. The instructions provide, based on the determination, an overutilization indication or an indication that the user-customized cable underutilizes the end fibers or utilizes each of the end fibers without overutilization.

### FIELD OF THE INVENTION

Embodiments of the present invention relate to systems, methods, and computer executable instructions for providing for customization of a user-customized cable, such as for manufacturing of the user-customized cable.

### BACKGROUND OF THE INVENTION

Previous systems permit the customization of cables generally, but the systems have several limitations that significantly increase the difficulty for users. Other systems also do not permit synchronization of sources. Thus, when the systems are utilized to make alterations to the cable in one screen, that information may not be updated in other areas, leading to inconsistency and inaccuracy of information. Further, other systems often are limited in their ability to serve as a multi-purpose tool, and visual content frequently must be created in one or more separate documents, often via hand sketch. Such an approach leads to inconsistencies, mistakes, and difficult in ultimate manufacturing of the desired cable.

### SUMMARY OF THE INVENTION

Various embodiments discussed herein provide systems, apparatuses, and methods that provide increased ease of use compared to other systems. Rather than requiring the user to cross-reference material from various different files, embodiments herein may receive updated information from the user and ensure that this updated information is shared with other relevant subsystems. This may increase the ease of use and efficiency for users, freeing up the users to focus on customization of their cable to meet their needs. By increasing the ease of use, a greater number of users may be able and willing to use the systems to customize and purchase cables. This also reduces errors and frustration by the purchaser.

Various embodiments provide a user-friendly graphical user interface that permits users to easily make alterations to a user-customized cable. A user-customized cable may be represented on the display, and the represented cable may be modified in real-time as cable properties for the cable are edited. The cable may be represented so that its footprint is maximized on the display. The cable represented on the display may be illustrated based on relative lengths of subunit cables, and presenting these relative lengths rather than the actual lengths may assist in maximizing the footprint and in making certain features more easily recognizable. The graphical user interface may permit customization of the cable in a variety of ways, such as by receiving specific length information, jacket color information, polarity information for cables, connector types, etc. Further, the graphical user interface may include a symmetrical mode where inputted properties for a first end of the cable are automatically applied at the second end.

Additionally, various embodiments discussed herein provide indications to users when the user has overutilized an available fiber count. Users may add or subtract subunit cables from their user-customized cable, and each of the subunit cables may impact the current number of end fibers in the user-customized cable. If the user has overutilized the end fibers so that the current number of end fibers exceeds the available fiber count, then an indication may be provided to the user to inform the user that overutilization has occurred. In some embodiments, a fiber utilization counter may be used to show the current number of end fibers used at a first end and a second end of the user-customized cable as well as the available fiber count, but indications may be provided in a variety of other ways. Where overutilization has occurred, a recommendation indication may be provided to the user of another potential available fiber count that may be used (e.g. the recommendation may suggest increasing the available fiber count from 72 fibers to 96 fibers), or a new available fiber count may be utilized automatically once overutilization has occurred.

Furthermore, various embodiments herein provide the ability to modify polarity assignments for connectors associated with a user-customized cable. Available polarity assignments may be determined for a given connector, and a selected polarity assignment may be received and saved in memory. Various polarity assignments may be made available such as an A to A polarity, an A to B polarity, a new custom polarity, and a previously saved custom polarity. Polarity schemes may be set for several connectors at the same time in some embodiments, and these polarity schemes may be set in memory for later use in some embodiments. The polarity schemes may be uniform polarity schemes where the same polarity assignment is made for each connector, but non-uniform polarity schemes may be used in other embodiments. Further, where a graphical user interface is utilized, properties related to polarity may be received in a cable properties portion of the graphical user interface, and these properties may be reflected in a representation of the user-customized cable that is presented on a display.

In an example embodiment, a non-transitory computer readable medium is provided having stored thereon a plurality of computer-executable instructions which, when executed by processing circuitry, cause the processing circuitry to perform certain tasks. These tasks include determining an available fiber count corresponding to creation of a user-customized cable. The user-customized cable includes a primary cable and at least one subunit cable. The at least one subunit cable includes at least one end fiber, and the available fiber count is a theoretical number of end fibers available in the primary cable. The tasks also include receiving at least one user input indicating addition or subtraction of a subunit cable on at least one of a first end of the user-customized cable or a second end of the user-customized cable; determining a current number of end fibers of the user-customized cable; making a determination as to whether the available fiber count is less than the current number of end fibers; and providing, based on the determination, an indicator. The indicator comprises an overutilization indication to indicate that the user-customized cable overutilizes end fibers; or an allowable utilization indication to indicate that the user-customized cable underutilizes the end fibers or utilizes each of the end fibers without overutilization.

In some embodiments, the computer-executable instructions may be configured to cause the processing circuitry to provide, upon a determination that the available fiber count is less than the current number of end fibers, the overutilization indication to indicate that the user-customized cable overutilizes the end fibers. Furthermore, in some embodiments, the computer-executable instructions may be configured to cause the processing circuitry to provide, upon a determination that the available fiber count is not less than the current number of end fibers, the indication that the user-customized cable underutilizes the end fibers or utilizes each of the end fibers without overutilization. In some embodiments, the computer-executable instructions may be configured to cause the processing circuitry to provide, upon a determination that the available fiber count is greater than the current number of end fibers, an indication that the user-customized cable underutilizes the end fibers. Additionally, in some embodiments, the computer-executable instructions may be configured to cause the processing circuitry to provide, upon a determination that the available fiber count is equal to the current number of end fibers, an indication that the user-customized cable utilizes each of the end fibers without overutilization.

In some embodiments, the computer-executable instructions may be configured to cause the processing circuitry to provide the indicator by performing at least one of sending a signal having the indicator; presenting on a display the current number of end fibers; presenting on the display a number of end fibers associated with a representation of a subunit cable; presenting on the display a symbol that indicates the current number of end fibers; or presenting on the display an item in a first color.

In some embodiments, the computer-executable instructions may be configured to cause the processing circuitry to provide an indication of the current number of end fibers. In some related embodiments, the computer-executable instructions may be configured to cause the processing circuitry to provide the indication of the current number of end fibers by performing at least one of sending a signal having the indication of the current number of end fibers; presenting on a display the current number of end fibers; presenting on the display a number of end fibers associated with a representation of a subunit cable; presenting on the display a symbol that indicates the current number of end fibers; or presenting on the display an item in a first color. Further, in some embodiments, the computer-executable instructions may be configured to cause the processing circuitry to provide an indication of a current number of end fibers for the first end of the user-customized cable; and provide an indication of a current number of end fibers for the second end of the user-customized cable.

In some embodiments, the computer-executable instructions may be configured to cause the processing circuitry to provide, upon a determination that the available fiber count is less than the current number of end fibers, a recommendation to the user of an available fiber count that does not result in overutilization. In some related embodiments, the available fiber count may be initially set at a count of seventy two end fibers, the current number of end fibers may be between seventy three end fibers and ninety six end fibers, and the recommendation to the user may suggest a new available fiber count of ninety six end fibers.

In some embodiments, the computer-executable instructions may be configured to cause the processing circuitry to increase the available fiber count automatically upon a determination that the available fiber count is less than the current number of end fibers.

In some embodiments, the at least one subunit cable may include a breakout cable and at least one leg cable within the breakout cable, and each leg cable of the at least one leg cable may include a plurality of end fibers therein. The current number of end fibers at the first end of the user-customized cable may be determined by adding a number of end fibers in each leg cable on the first end of the user-customized cable together.

In some embodiments, the computer-executable instructions may be configured to cause the processing circuitry to determine a first number of end fibers at the first end of the user-customized cable; determine a second number of end fibers at the second end of the user-customized cable; make a first determination as to whether the available fiber count is less than the first number of end fibers; make a second determination as to whether the available fiber count is less than the second number of end fibers; and provide the indicator based on the first determination and the second determination. The indicator may include the overutilization indication to indicate that the user-customized cable overutilizes the end fibers, or the indicator may include the allowable utilization indication that the user-customized cable underutilizes the end fibers or utilizes each of the end fibers without overutilization.

In another example embodiment, a method is provided for indicating whether a user-customized cable overutilizes end fibers. The method includes determining an available fiber count corresponding to creation of the user-customized cable. The user-customized cable includes a primary cable and at least one subunit cable, and the at least one subunit cable includes at least one end fiber. The available fiber count is a theoretical number of end fibers available in the primary cable. The method also includes receiving at least one user input indicating addition or subtraction of a subunit cable on at least one of a first end of the user-customized cable or a second end of the user-customized cable (with the subunit cable including one or more end fibers); determining a current number of end fibers of the user-customized cable; making a determination as to whether the available fiber count is less than the current number of end fibers; and providing, based on the determination, an indicator. The indicator may include an overutilization indication to indicate that the user-customized cable overutilizes end fibers, or the indicator may include an allowable utilization indication to indicate that the user-customized cable underutilizes the end fibers or utilizes each of the end fibers without overutilization.

In some embodiments, the method may also include providing, upon a determination that the available fiber count is less than the current number of end fibers, an overutilization indication to indicate that the user-customized cable overutilizes the fibers. In some related embodiments, the method may also include providing the indicator by performing at least one of sending a signal having the indicator; presenting on a display the current number of end fibers; presenting on the display a number of end fibers associated with a representation of a subunit cable; presenting on the display a symbol that indicates the current number of end fibers; or presenting on the display an item in a first color.

In some embodiments, the method may include providing an indication of the current number of end fibers. In some related embodiments, the method may also include providing the indication of the current number of end fibers by performing at least one of sending a signal having the indication of the current number of end fibers; presenting on a display the current number of end fibers; presenting on the display a number of end fibers associated with a representation of a subunit cable; presenting on the display a symbol that indicates the current number of end fibers; or presenting on the display an item in a first color. Further, in some embodiments, the method may include providing an indication of a current number of end fibers for the first end of the user-customized cable, and the method may also include providing an indication of a current number of end fibers for the second end of the user-customized cable.

In some embodiments, determining the current number of end fibers in the user-customized cable may involve determining a first number of end fibers in the user-customized cable at the first end of the user-customized cable and determining a second number of end fibers in the user-customized cable at the second end of the user-customized cable. Further, making the determination as to whether the available fiber count is less than the current number of end fibers may involve making a first determination as to whether the available fiber count is less than the first number of end fibers and making a second determination as to whether the available fiber count is less than the second number of end fibers. The method may also include providing, based on the first determination and the second determination, the indicator selected from the group consisting of the overutilization indication to indicate that the user-customized cable overutilizes the end fibers; or the allowable utilization indication that the user-customized cable underutilizes the fibers or utilizes each of the end fibers without overutilization.

In another example embodiment, a graphical user interface is provided for creation of a user-customized cable. The graphical user interface includes a cable illustration portion having a cable representation, and the cable representation includes a representation of the user-customized cable. The graphical user interface also includes an indication portion. The graphical user interface is configured to determine an available fiber count corresponding to the creation of the user-customized cable. The user-customized cable includes a primary cable and at least one subunit cable, and the at least one subunit cable includes at least one end fiber. The available fiber count is a theoretical number of end fibers available in the primary cable. The graphical user interface is also configured to receive at least one user input indicating addition or subtraction of a subunit cable on at least one of a first end of the user-customized cable or a second end of the user-customized cable; determine a current number of end fibers of the user-customized cable; make a determination as to whether the available fiber count is less than the current number of end fibers; and provide, based on the determination, an indicator within the indication portion. The indicator includes an overutilization indication to indicate that the user-customized cable overutilizes end fibers, or the indicator includes an allowable utilization indication that the user-customized cable underutilizes the end fibers or utilizes each of the end fibers without overutilization.

Further areas of applicability of the present invention will become apparent from the detailed description provided hereinafter. It should be understood that the detailed description and specific examples, while indicating examples of preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1A is a schematic view illustrating a display that is presenting an example representation of a user-customized cable, in accordance with some embodiments discussed herein;

FIG. 1B illustrates a cable properties portion that may be presented on a display, in accordance with some embodiments discussed herein;

FIG. 1C illustrates a cable properties portion that may be presented on a display, in accordance with some embodiments discussed herein;

FIG. 1D illustrates a cable illustration portion that may be presented on a display with a representation of a user-customized cable therein, in accordance with some embodiments discussed herein;

FIG. 1E is an enhanced view of the cable illustration portion of FIG. 1D where features in representations of a breakout cable and leg cables are illustrated, in accordance with some embodiments discussed herein;

FIG. 2A illustrates a cable illustration portion with a representation of another example user-customized cable having only one leg cable on each end, in accordance with some embodiments discussed herein;

FIG. 2B illustrates a cable illustration portion with a representation of another example user-customized cable having a plurality of leg cables on each end, in accordance with some embodiments discussed herein;

FIG. 2C illustrates a cable illustration portion with another example representation of a user-customized cable having a plurality of leg cables on a first end and only one leg cable on a second end, in accordance with some embodiments discussed herein;

FIG. 3A illustrates an enhanced view of a cable illustration portion where representations of leg cables have staggered length values and where organized length measurements are presented, in accordance with some embodiments discussed herein;

FIG. 3B is an enhanced view illustrating another approach for representing length measurements in the cable illustration portion having increased clutter, in accordance with some embodiments discussed herein;

FIG. 4A is an enhanced view illustrating a cable illustration portion where representations of a breakout cable and leg cables therein are selected and highlighted, in accordance with some embodiments discussed herein;

FIG. 4B illustrates a tabular display portion having a table with editable properties for the user-customized cable, in accordance with some embodiments discussed herein;

FIG. 4C is an enhanced view illustrating features of representations of leg cables in a cable illustration portion, in accordance with some embodiments discussed herein;

FIG. 4D illustrates a tabular display portion having a table with editable properties for the user-customized cable, in accordance with some embodiments discussed herein;

FIG. 5 is an enhanced view illustrating a cable illustration portion with representations of a breakout cable and leg cables therein, where relative lengths of cables are represented, in accordance with some embodiments discussed herein;

FIG. 6A is an enhanced view illustrating a representation of a leg cable and an associated connector represented in a cable illustration portion, in accordance with some embodiments discussed herein;

FIG. 6B illustrates a cable properties portion that may be presented on a display, in accordance with some embodiments discussed herein;

FIG. 6C is an enhanced view illustrating a representation of a leg cable and an associated connector represented in a cable illustration portion, in accordance with some embodiments discussed herein;

FIG. 6D illustrates a cable properties portion that may be presented on a display, in accordance with some embodiments discussed herein;

FIG. 7A illustrates a polarity assignment portion where available polarity assignments may be selected for connectors, in accordance with some embodiments discussed herein;

FIG. 7B illustrates the polarity assignment portion of FIG. 7A where a list of available polarity assignments is presented, in accordance with some embodiments discussed herein;

FIG. 7C illustrates a cable illustration portion including indications relevant to the polarity assignments, in accordance with some embodiments discussed herein;

FIG. 7D is an enhanced view of the cable illustration portion of FIG. 7C, in accordance with some embodiments discussed herein;

FIG. 8A illustrates another cable illustration portion having indications relevant to the polarity assignments, in accordance with some embodiments discussed herein;

FIG. 8B illustrates another polarity assignment portion where available polarity assignments may be selected for connectors, with the polarity assignment portion corresponding to the cable illustration portion of FIG. 8A, in accordance with some embodiments discussed herein;

FIG. 9A illustrates a custom polarity assignment portion, in accordance with some embodiments discussed herein;

FIG. 9B illustrates a pop-up screen that may be used to name a created polarity scheme, in accordance with some embodiments discussed herein;

FIG. 9C illustrates another polarity assignment portion after a custom polarity scheme has been created and saved in memory, in accordance with some embodiments discussed herein;

FIG. 10A illustrates a polarity scheme display where a polarity scheme for a connector is illustrated, in accordance with some embodiments discussed herein;

FIG. 10B illustrates another polarity scheme display where a polarity scheme for a connector is illustrated, in accordance with some embodiments discussed herein;

FIG. 11A illustrates a length customization table where length properties and other properties for cables may be seen, in accordance with some embodiments discussed herein;

FIG. 11B illustrates a polarity customization table that may be used to show polarity and other properties for cables, in accordance with some embodiments discussed herein;

FIG. 12A illustrates a cable illustration portion being used to create a bill of materials, in accordance with some embodiments discussed herein;

FIG. 12B illustrates a bill of materials customization table that may be used to preview and make changes to the bill of materials, in accordance with some embodiments discussed herein;

FIG. 12C illustrates an example final bill of materials, in accordance with some embodiments discussed herein;

FIG. 12D illustrates an additional table that may be provided alongside the final bill of materials, in accordance with some embodiments discussed herein;

FIG. 13A illustrates a selection menu being used to print a drawing image of a user-customized cable, in accordance with some embodiments discussed herein;

FIG. 13B illustrates a drawing image of a user-customized cable, in accordance with some embodiments discussed herein;

FIG. 14 is a block diagram illustrating various components that may be used, in accordance with some embodiments discussed herein;

FIG. 15 is a block diagram illustrating a various items that may be presented in a graphical user interface, in accordance with some embodiments discussed herein;

FIG. 16 is a flow chart illustrating a method of presenting items in a graphical user interface, in accordance with some embodiments discussed herein;

FIG. 17 is a flow chart illustrating a method of inputting properties for connectors or cables in a user-customized cable using a symmetrical mode, in accordance with some embodiments discussed herein;

FIG. 18 is a flow chart illustrating another method of inputting properties for connectors or cables in a user-customized cable using an asymmetrical mode, in accordance with some embodiments discussed herein;

FIG. 19 is a flow chart illustrating a method for indicating overutilization of available fibers within a user-customized cable, in accordance with some embodiments discussed herein;

FIG. 20 is a flow chart illustrating a method for making polarity assignments for connectors, in accordance with some embodiments discussed herein;

FIG. 21 is a flow chart illustrating a method for making custom polarity assignments for connectors, in accordance with some embodiments discussed herein;

FIG. 22 is a flow chart illustrating a method for inputting polarity schemes for multiple groups of connectors, in accordance with some embodiments discussed herein;

FIG. 23 is a flow chart illustrating a method for creating a polarity scheme, in accordance with some embodiments discussed herein; and

FIG. 24 is a cross sectional view illustrating an example primary cable with subunit cables within the primary cable, in accordance with some embodiments discussed herein.

### DETAILED DESCRIPTION

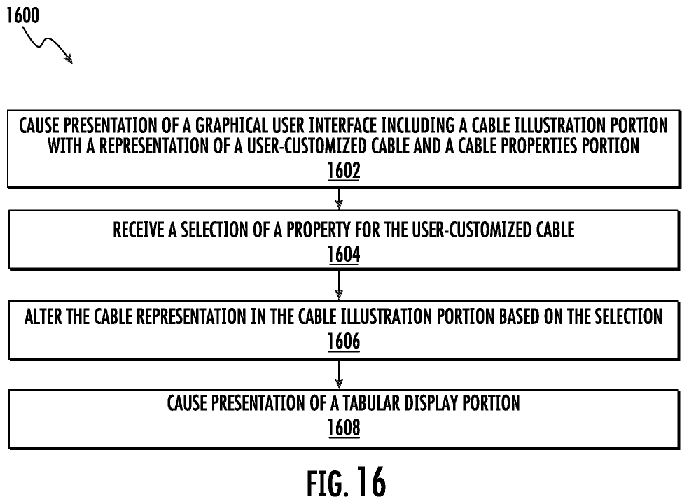

The following description of the embodiments of the present invention is merely exemplary in nature and is in no way intended to limit the invention, its application, or uses. The following description is provided herein solely by way of example for purposes of providing an enabling disclosure of the invention but does not limit the scope or substance of the invention. With the exception of items illustrated in FIGS. 16-23, like numerals are intended to refer to the same or similar components (e.g. numerals 114, 214, 314, etc. each refer to a connector).

As used in this disclosure, the term “fiber” is short-hand for “optical fiber.” As used in this disclosure, “polarity” refers to the positioning of optical fibers to ensure connectivity between transmitter(s) and receiver(s). As used in this disclosure, the term “polarity assignment” refers to the assignment of a particular position on an end of an optical fiber assembly with that of another particular position on the other end of the optical fiber assembly. Additionally, as used in this disclosure, the term “polarity scheme” refers to a collection of polarity assignments for a plurality of connectors. As used in this disclosure, “A to A polarity” refers to a polarity assignment or polarity scheme where the ends of optical fibers of the optical fiber assembly are assigned to a same position (“Position A”) on each end of the optical fiber assembly. Further, “A to B polarity” refers to a polarity assignment or polarity scheme where the ends of optical fibers of the optical fiber assembly have an end in a Position A on one end of the optical fiber assembly and have the other end in an opposite position (“Position B”) on the other end of the optical fiber assembly. As used in this disclosure, a “polarity assignment item” refers to an item that indicates whether a polarity assignment has been made for a connector.

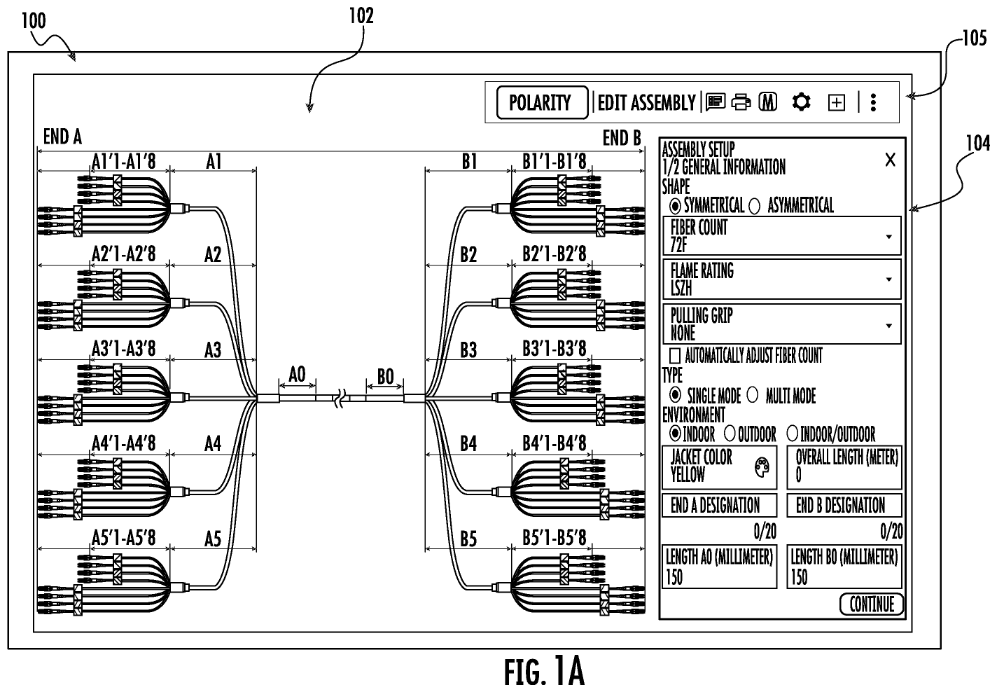

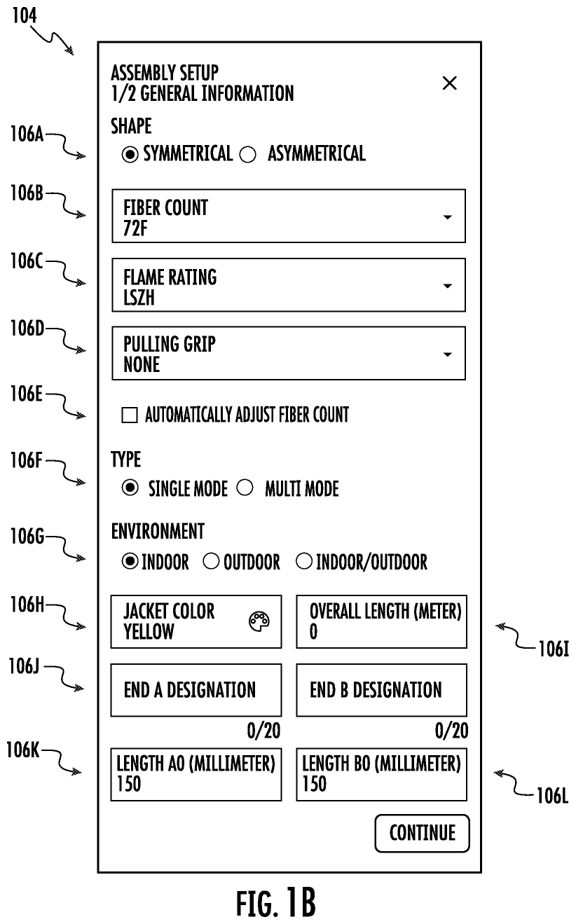

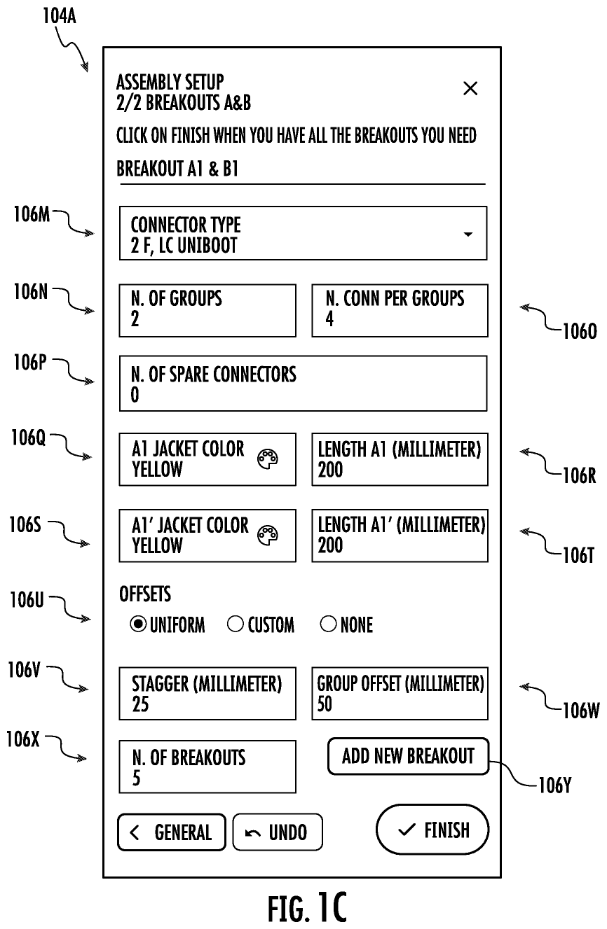

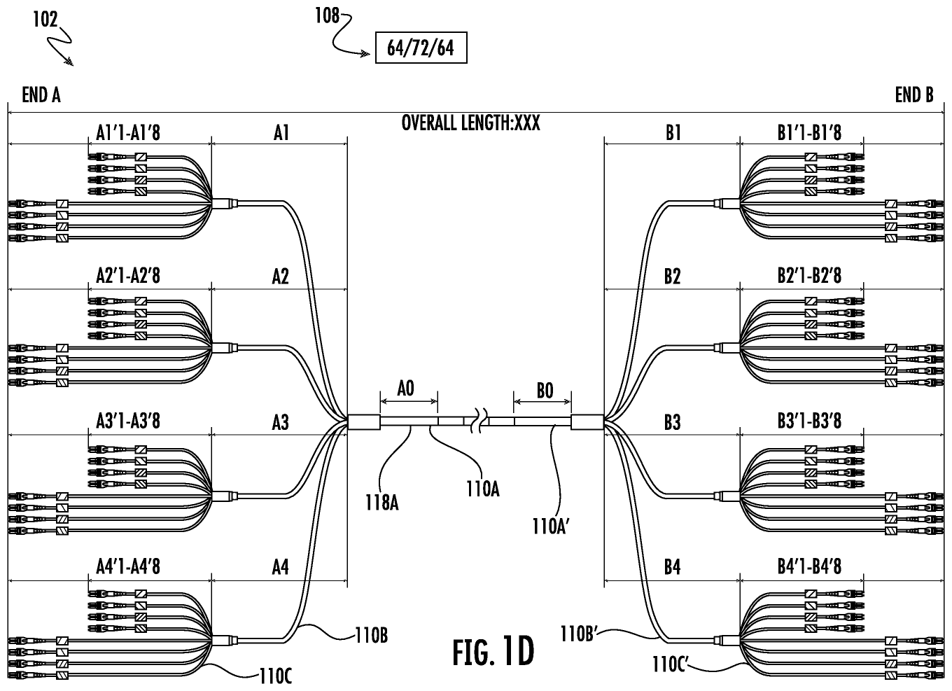

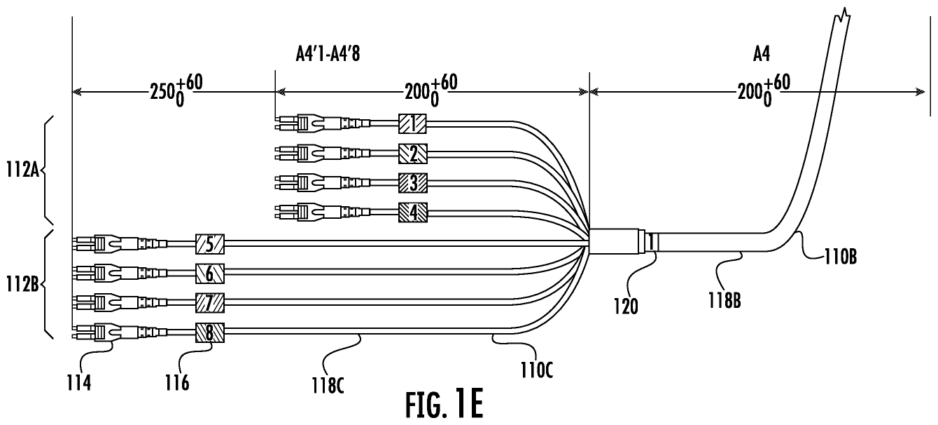

Various embodiments discussed herein provide systems, methods, and computer-executable instructions for permitting user-friendly customization of a user-customized cable, which in some embodiments, may include providing a graphical user interface for user-friendly customization of a user-customized cable. FIG. 1A is a schematic view illustrating a display 100 that is presenting a graphical user interface that may be presented on the display 100. The graphical user interface may include a cable illustration portion 102, a cable properties portion 104, and a selection menu 105. As illustrated, the cable illustration portion 102, the cable properties portion 104, and the selection menu 105 may be presented simultaneously on the display 100 in some embodiments.

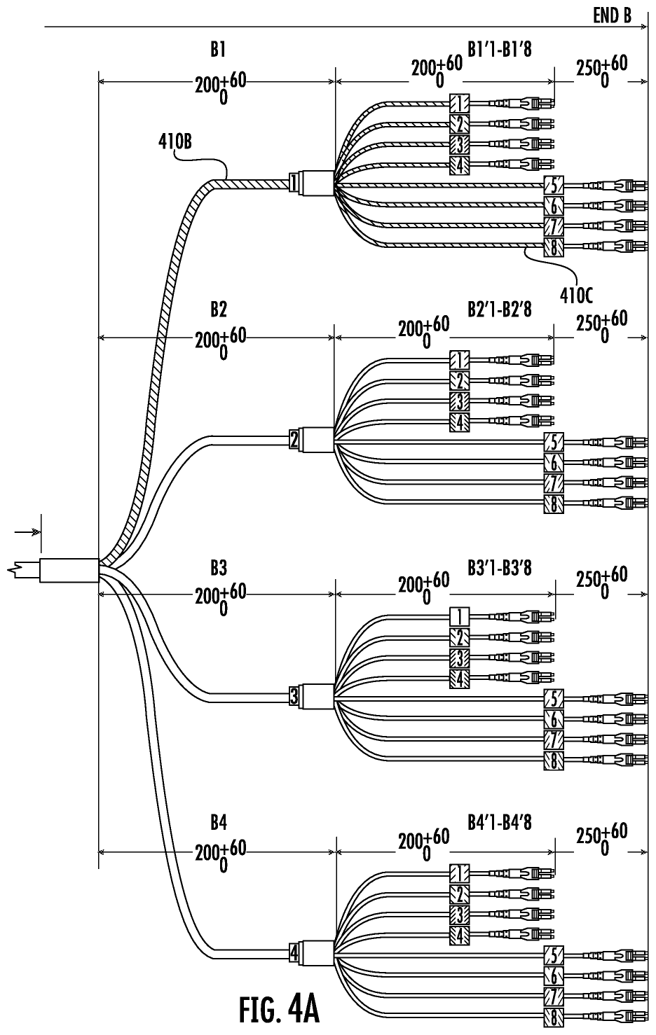

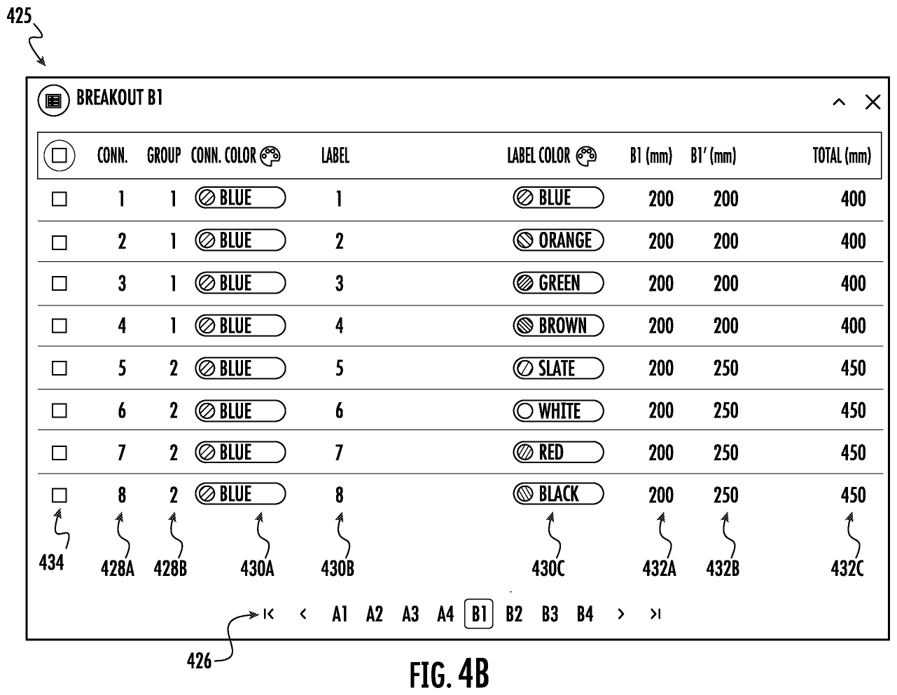

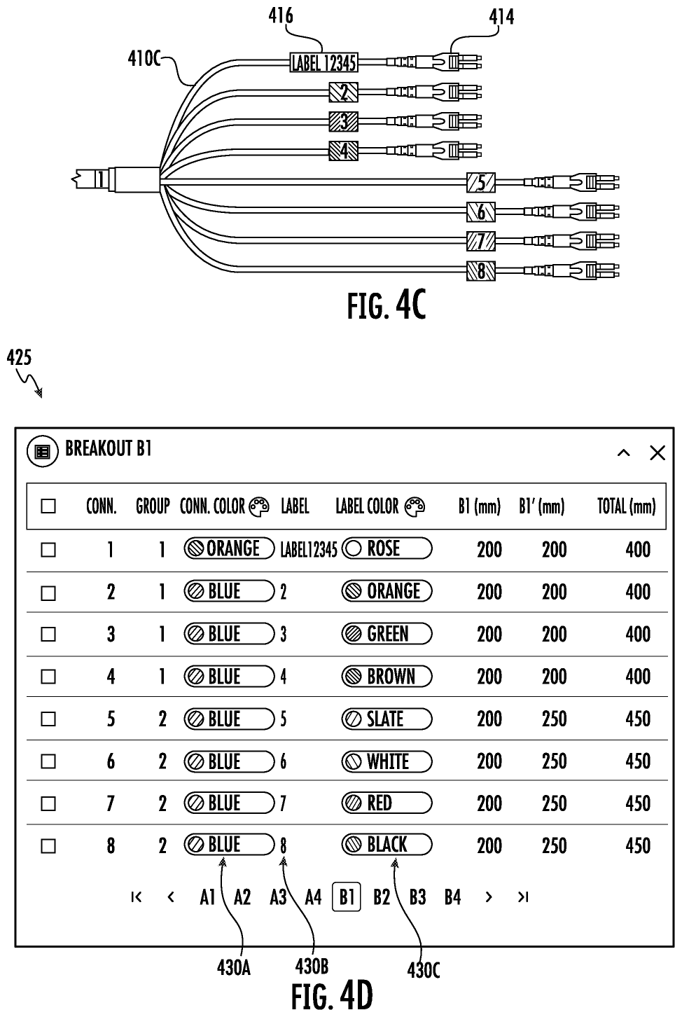

Other views included herein zoom in on certain features within the graphical user interface so that they may be more easily understood. FIGS. 1B and 1C illustrate a cable properties portion 104 that may be presented on a display 100 (see FIG. 1A), with FIG. 1B illustrating a first set of editable cable properties and with FIG. 1C illustrating a second set of editable cable properties. The cable properties portion 104 may be presented alone on the display 100 (see FIG. 1A) in some embodiments. However, in other embodiments, the cable properties portion 104 may be presented simultaneously on the display 100 (see FIG. 1A) alongside other elements such as the cable illustration portion 102, the selection menu 105, tabular display portion 425 (see FIG. 4B), etc.

The cable properties portion 104 presents fields 106A to permit selection of a symmetrical mode or an asymmetrical mode. Where a symmetrical mode is selected, properties may be received for a first connector on a first end of the user-customized cable, and these properties may be applied automatically for a corresponding second connector on the second end of the user-customized cable. However, where an asymmetrical mode is selected, a user may manually input properties for connectors on the first end and the second end of the user-customized cable. In some embodiments, the symmetrical mode may be the default mode. The default selection at field 106A may be the symmetrical mode in some embodiments.

The cable properties portion 104 presents a field 106B where an available fiber count may be selected. This available fiber count may be the theoretical number of end fibers that are available in a given primary cable. In FIG. 1B, the field 106B is set to select an available fiber count of 72. However, other available fiber counts may be utilized. For example, the available fiber count may be 24, 36, 48, 96, 108, 144, etc. The depicted example fiber counts are base 12, however other fiber multiples may also be utilized, such as base 8. Once this available fiber count is set, it may be presented in the cable illustration portion 102 at fiber utilization counter 108. The available fiber count may be provided as the center number in the fiber utilization counter 108 (shown in FIG. 1D), with the current number of end fibers for the first end and the second end of the user-customized cable being provided on the right and the left respectively. In some embodiments, the fiber utilization counter 108 may serve as an indication portion that may be presented on the display 100 (see FIG. 1A). However, the indication portion may be provided in other ways as well (e.g. in other locations, through use of colors, through warning text, etc.).

The cable properties portion 104 presents several other fields where cable properties for the user-customized cable may be received. Field 106C permits a flame rating for the user-customized cable to be selected, with a low-smoke zero halogen (LSZH) flame rating being selected in the illustrated embodiment. However, other flame rated cables may be selected such as optical fiber conductive plenum (OFCP) cables, optical fiber non-conductive plenum (OFNP) cables, class three plenum (CL3P) cables, optical fiber conductive riser (OFCR) cables, optical fiber non-conductive riser (OFNR) cables, etc.

Field 106D permits a pulling grip to be added at one or more of the cables within the user-customized cable. For example, a pulling grip may be added for some or all of the leg cables, for some or all of the breakout cables, and for some or all of the primary cables. However, in the illustrated embodiment in FIG. 1B, no pulling grip is added for the user-customized cable.

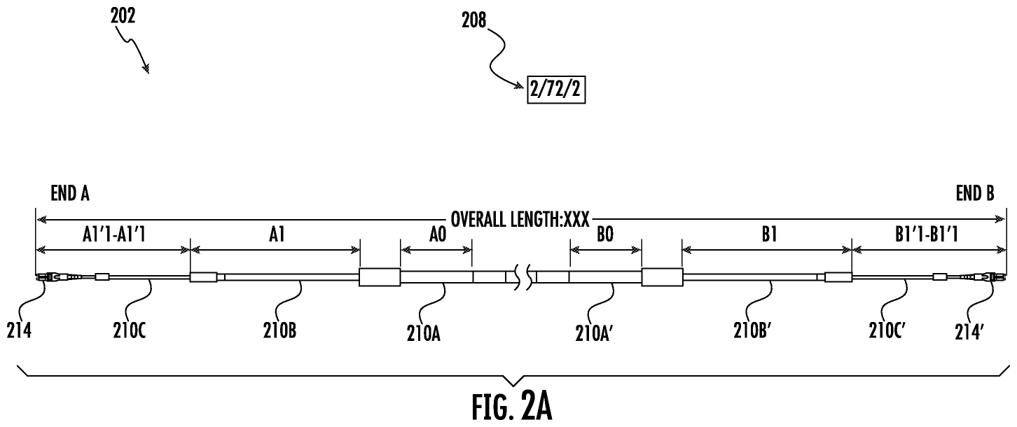

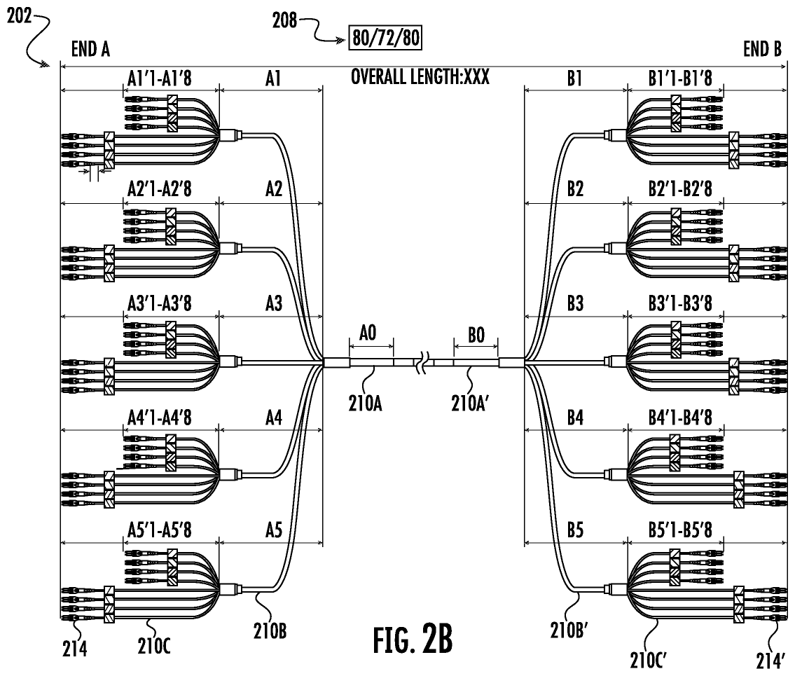

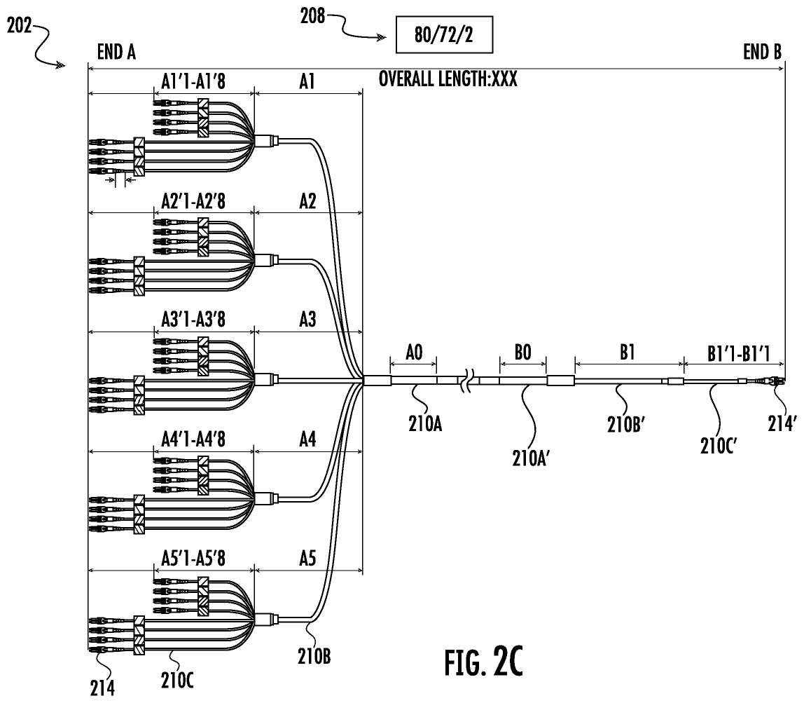

Field 106E permits a user to select whether the available fiber count selected in field 106B should be automatically adjusted. If the user edits the user-customized cable so that the current number of end fibers in user-customized cable exceeds the available fiber count selected in 106B, then the user has overutilized the available fiber count. For example, in FIG. 2B, the representation of the user-customized cable illustrated in the cable illustration portion 202 overutilizes fibers, with the current number of end fibers being eighty and with the available fiber count being only seventy two. Where overutilization occurs and field 106E is not selected, the available fiber count is not automatically increased. However, if overutilization has occurred and the field 106E is selected, then the available fiber count is automatically increased. In some embodiments, the available fiber count may simply increase to the next available fiber count (e.g. from an available fiber count of 72 to an available fiber count of 96).

Other fields may be provided to receive other inputs. For example, field 106F receives input as to whether the single mode or multi mode fibers are to be used for the user-customized cable. Field 106G receives input as to whether the user-customized cable are to be used for in an indoor setting, an outdoor setting, or potentially in both settings. Field 106H may receive an input for the jacket color of the primary cable. Furthermore, the fields 106J may receive text inputs with designations for the first end and the second end of the user-customized cable.

Additionally, length information may be received in field 106I, field 106K, and field 106L. The overall length of the user-customized cable may be set in field 106I, and this overall length may be presented in the cable illustration portion 102 in some embodiments as illustrated in FIG. 1D. Furthermore, the field 106K may allow for the length of a first primary cable segment 210A (see FIG. 2A) to be set, and the field 106L may allow for the length of a second primary cable segment 210A′ (see FIG. 2A) to be set.

Furthermore, the user-customized cable may include a primary cable and subunit cables within the primary cable. An example of this is illustrated in FIG. 1D. In the representation of the user-customized cable illustrated in the cable illustration portion 102, representations are provided of a primary cable with a first segment 110A and a second segment 110A′. Further, the represented user-customized cable may include one or more breakout cables 110B, 110B′ within the primary cable and one or more leg cables 110C, 110C′ within each breakout cable. However, additional cables may also be provided within the leg cables 110C, 110C′ in some embodiments. Breakout cables 110B may be provided towards the first end of the user-customized cable, and breakout cables 110B′ may be provided towards the second end of the user-customized cable. Furthermore, the leg cables 110C may be provided towards the first end of the user-customized cable, and leg cables 110C′ may be provided towards the second end of the user-customized cable.

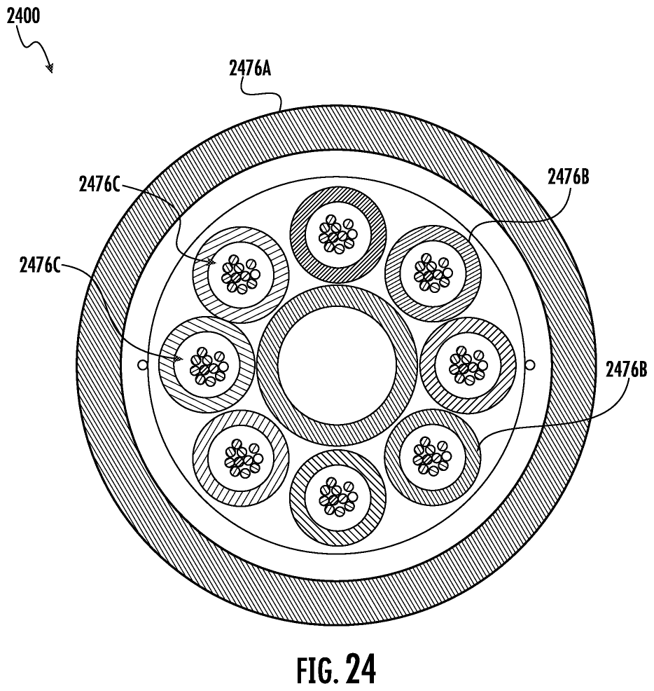

As another example, FIG. 24 illustrates a cross sectional view of an example primary cable in one embodiment. The primary cable 2476A may include one or more subunit cables inside of the primary cable 2476A. These subunit cables may, for example, be breakout cables 2476B, leg cables 2476C, or additional cables. Breakout cables 2476B may be provided within the primary cable 2476A, and the leg cables 2476C may be provided within the breakout cables 2476B. While additional cables are not included in this embodiment, these additional cables may be provided in the leg cables 2476C in some embodiments.

Looking back at FIG. 1D, the leg cables 110C, 110C′ may be separated into groups within the breakout cables 110B, 110B′. This may be seen most easily in the enhanced view of FIG. 1E, which focuses on a representation of the breakout cable 110B in the bottom left portion of FIG. 1D. A first group 112A of leg cables 110C and a second group 112B of leg cables 110C are represented. The first group 112A and the second group 112B may be configured so that the leg cables 110C in the two groups extend at different lengths. For example, the leg cables 110C of the second group 112B extend approximately 50 millimeters longer than the leg cables 110C of the first group 112A in the illustrated embodiment of FIG. 1E.

Also, as illustrated in FIG. 1E, a connector 114 may be provided at the end of each leg cable 110C. The connector 114 may be associated with a specified number of end fibers. In the illustrated embodiment, the represented connectors 114 each have two associated end fibers. Thus, with two end fibers associated with each connector 114 and leg cable 110C, there are 16 end fibers associated with each breakout cable 110B, and there are 72 end fibers associated with the primary cable (see FIG. 1D). Further features illustrated in FIG. 1E are described further below.

Turning back to FIG. 1C, a second set of editable cable properties in a second cable properties portion 104A are illustrated. For the embodiment illustrated in FIG. 1C, the user-customized cable has a primary cable, breakout cables, and leg cables, and connectors are provided at the end of each leg cable. In the second cable properties portion 104A of FIG. 1C, the symmetric mode is active, and properties may be selected for both a specific breakout cable on a first end of the user-customized cable and a corresponding breakout cable on the second end of the user-customized cable. However, where an asymmetric mode is active, the user may manually input cable properties for breakouts on the first end and the second end of the user-customized cable.

In field 106M, a connector type may be selected for connectors associated with the breakout cable. This connector type may include a two fiber, LC Uniboot connector as illustrated in FIG. 1C, but other connector types are available such as other LC connectors (e.g., according to IEC 61754-20:2012); a subscriber connector (SC) (e.g., according to according to IEC 61754-4:2013); a multi-fiber Push On (MPO) connector (e.g., according to IEC 61754-7-2: 2019), such as the multi-fiber termination push-on (MTP) offered by US Conec, Ltd. (Hickory, NC); very small form factor (VSFF) connectors such as MDC connectors (sometimes referred to as “mini duplex connectors”) offered by U.S. Conec, Ltd. (Hickory, NC); and SN connectors (sometimes referred to as a Senko Next-generation connectors) offered by Senko Advanced Components, Inc. (Marlborough, MA). The connector types may therefore include simplex, duplex, or multifiber connectors, with such connectors including any type of end face geometry, such as physical contact (PC), ultra physical contact (UPC), and angled physical contact (APC) geometries. Certain connector types may also include pinned and unpinned versions, as is the case for MPO connectors. Other connector types may be made available as well.

Turning back to FIG. 1C, field 106N, field 106O, and field 106P may permit selections to customize how leg cables are organized within breakout cables. As discussed herein in reference to FIGS. 1D and 1E, leg cables within a single breakout cable may be organized into groups 112A, 112B (see FIG. 1E). Field 106N permits a selection of the number of groups within the breakout cable that is being customized, and field 106O permits selection of a number of leg cables or connectors within each of these groups. Further, field 106P permits selection of a number of spare connectors that are not within the groups. In the illustrated embodiment of FIG. 1C, the represented breakout cable is customized to have eight leg cables, with the leg cables divided into two groups of four leg cables. An example of such a user-customized cable is also illustrated in FIG. 1E. However, the cable properties portion 104, 104A is configured to permit a wide array of customizations. For example, nine leg cables may be provided in a breakout cable, with the leg cables divided into four groups of two leg cables and with one spare connector. As another example, eighteen leg cables may be provided in a breakout cable, with the leg cables divided into four groups of four leg cables and with two spare connectors. Various other combinations could also be used.

Field 106Q permits selection of a jacket color for the breakout cable, and field 106S permits selection of the jacket color for leg cables within the breakout cable. The jacket colors selected at field 106Q for the breakout cable, at field 106S for the leg cables, and at field 106H (see FIG. 1B) for the primary cable may be different from each other in some embodiments. However, a yellow jacket color is selected for each of these cables in the illustrated embodiment.

As illustrated in FIGS. 1D and 1E, changes may be made in the cable illustration portion 102 based on the selected jacket colors. These changes may be simultaneously made in the cable illustration portion 102 in some embodiments. For example, the jacket color selected at field 106H may be reflected in the jacket 118A (see FIG. 1D) of the primary cable, the jacket color selected at field 106Q may be reflected in the jacket 118B (see FIG. 1E) of the breakout cable 110B, and the jacket color selected at field 106S may be reflected in the jacket 118C of the leg cable 110C.

Turning back to FIG. 1C, general length information may also be input at field 106R and at field 106T. Field 106R may set the length for breakout cables, with this length being the length that the breakout cables freely extend outside of the primary cable on the first end or the second end. In the illustrated embodiment, the field 106R sets the length of the breakout cables at 200 millimeters. However, other lengths may be used, and the lengths may be altered so that they are presented in inches or in some other unit. Field 106T may set the length for leg cables, with this length being the length that the leg cables freely extend outside of the breakout cable on the first end. In the illustrated embodiment, the field 106T sets the length of the leg cables at 200 millimeters, but other lengths may also be used.

Field 106I (see FIG. 1B), field 106K (see FIG. 1B), field 106L (see FIG. 1B), field 106R, and field 106T may permit a user to set initial lengths for the user-customized cable. Further adjustments may be made to the lengths for the user-customized cable using field 106V, using field 106W, using the tabular display portion 425 (see FIG. 4B), or through other approaches.

At field 106W, a group offset value may be provided. FIG. 1E provides an example where a non-zero group offset value is provided. In FIG. 1E, a representation of the breakout cable 110B is illustrated, and leg cables 110C are provided in the breakout cable 110B. The leg cables 110C are divided into a first group 112A and a second group 112B. In the embodiment illustrated in FIG. 1E, the group offset value is 50 millimeters, and the leg cables 110C in the second group 112B each extend approximately 50 millimeters farther than the leg cables 110C in the first group 112B. Thus, the group offset value allows quick adjustments to the lengths of several leg cables, and a user may continue to refine the lengths further as desired. Where the group offset value at field 106W is set to zero, different groups of cables are not offset from each other.

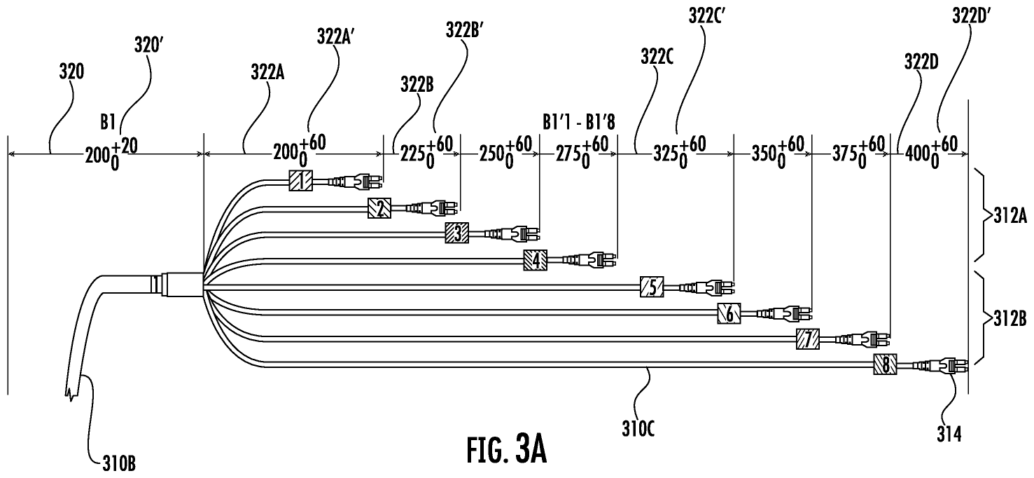

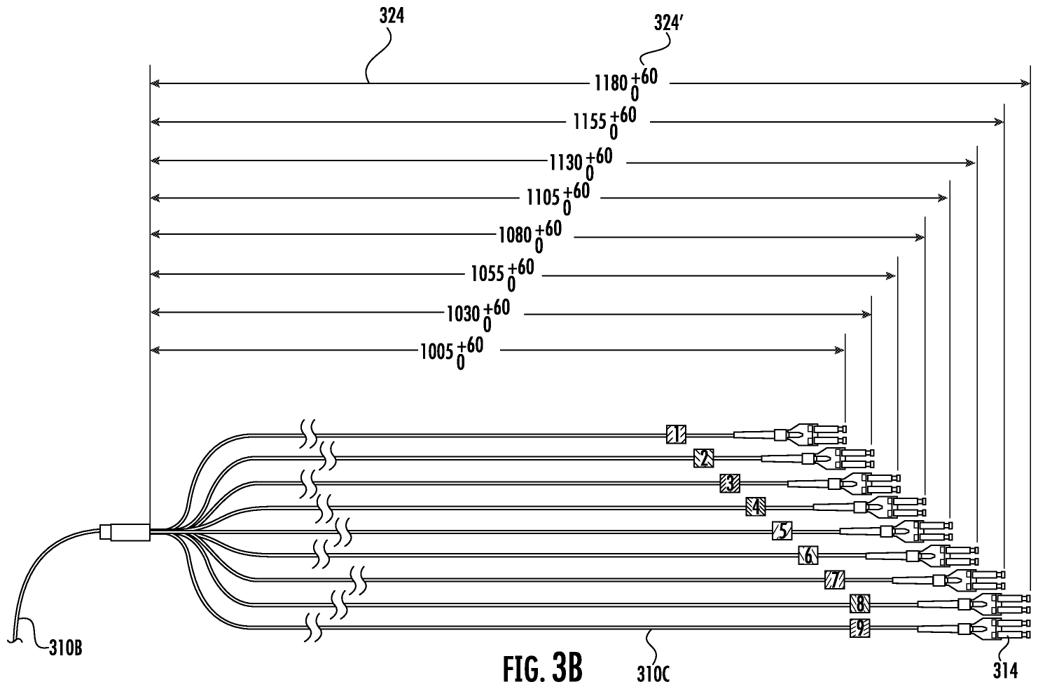

Turning back to FIG. 1C, a stagger value may be provided at field 106V. A stagger value of zero may result in cables in the same group having approximately the same length. By contrast, a non-zero stagger value results in cables in a group having varying lengths that increase continuously. In FIG. 1C, a stagger value is set at 25 millimeters in field 106V, and a group offset value is set at 50 millimeters in field 106W. FIG. 3A illustrates an example representation of a breakout cable 310 where these values are used. For the FIG. 3A embodiment, a first group 312A of leg cables 310C and a second group 312A of leg cables 310C are provided. The leg cables 310C in the first group 312A extend at lengths of 200 millimeters, 225 millimeters, 250 millimeters, and 275 millimeters respectively. Further, the leg cables 310C in the second group 312B extend at lengths of 325 millimeters, 350 millimeters, 375 millimeters, and 400 millimeters. The group offset value (set at 50 millimeters) may define the distance between the longest leg cable 310C of the first group 312A (275 millimeters) and the shortest leg cable 310C of the second group 312B (325 millimeters).

The embodiment illustrated in FIG. 3A also shows tolerance values in the length measurement values. For example, the length measurement value 322A′ includes the length of 200 mm as well as a tolerance range of +60 millimeters to 0 millimeters. As another example, the length measurement value 320′ includes the length of 200 mm as well as a tolerance range of +20 millimeters to 0 millimeters.

Looking again at FIG. 1C, a selection may be made at field 106U regarding the offset. A selection may be made as to whether offsets should be uniform, whether custom offsets should be used, or if offsets are to be used at all. Where a uniform offset selection is made, the user may complete the field 106V and the field 106W as illustrated. Where a selection is made to avoid any offset, field 106V and field 106W may be omitted. Where a custom selection is made at field 106U, the user may be prompted to input a separate stagger value and group offset value for each added group. In some embodiments, the stagger value set at field 106V and the group offset value set at field 106W may increase the length of certain leg cables beyond the length set in fields 106T.

Field 106X permits a number of breakout cables to be selected. This takes the properties that have been input for the breakout cable being customized and duplicates the properties for additional breakout cables. In the embodiment illustrated in FIG. 1C, the number of breakout cables is set to five in field 106X, so the properties may be set for five different breakout cables at the same time. In some embodiments, the systems may permit a user to duplicate the breakout cables and then make subsequent modifications so that the breakout cables differ from each other.

At field 106Y, a selection button is provided where a user may choose to add a new breakout cable. By doing so, the fields illustrated in FIG. 1C may be recompleted or modified for the new breakout cable. The selection button at field 106Y may permit breakout cables to be used with substantially different properties. Other buttons at the bottom of the illustrated cable properties portion in FIG. 1C permit the user to navigate back to the previous screen, to undo the previous change, and to finish the modifications in the cable properties portion 104.

In some embodiments, the cable illustration portion 102 or another window on the display 100 may include some indication of the selected properties for the user-customized cable once a selection has been made at one of the fields. For example, indications may be provided in the cable illustration portion 102 upon selection of a flame rating at field 106C or selection of a pulling grip at field 106D.

FIG. 1D illustrates a cable illustration portion that may be presented in a screen with a representation of a user-customized cable therein, and FIG. 1E is an enhanced view of the cable illustration portion of FIG. 1D where features in a representation of a breakout cable and leg cables may be seen.

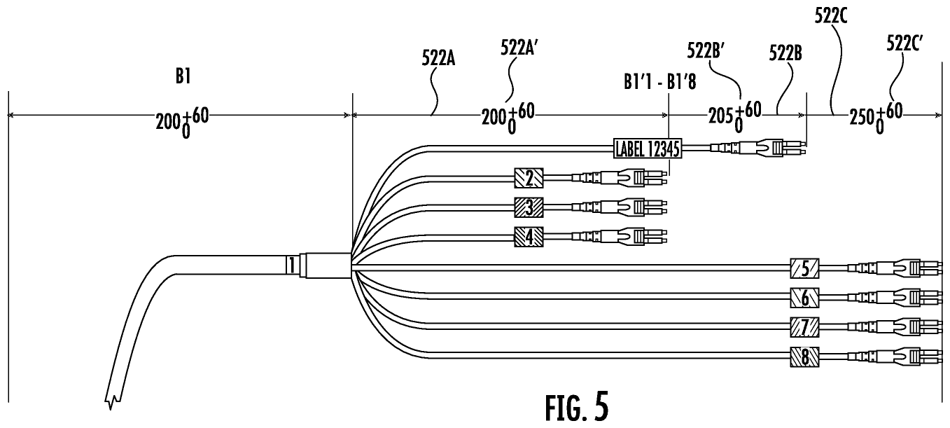

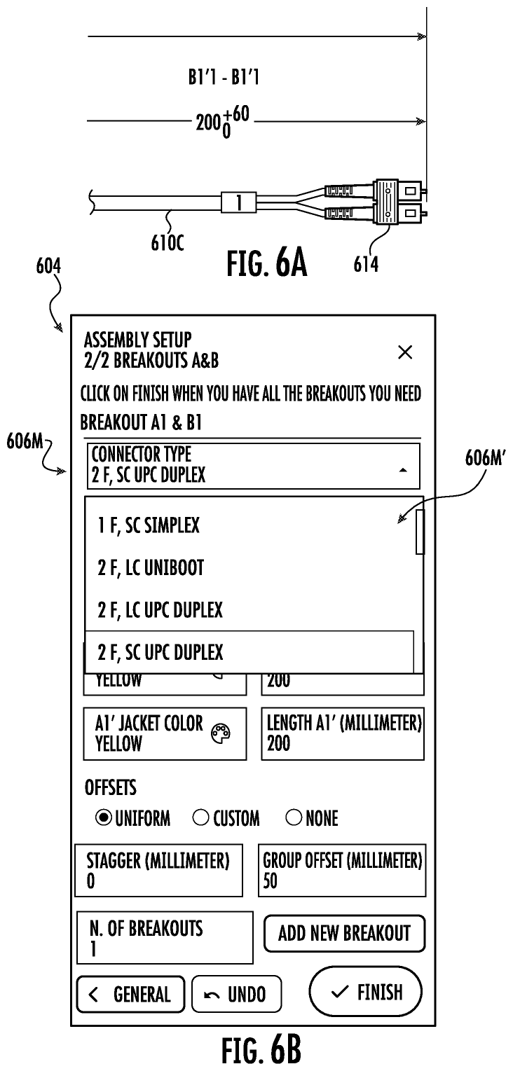

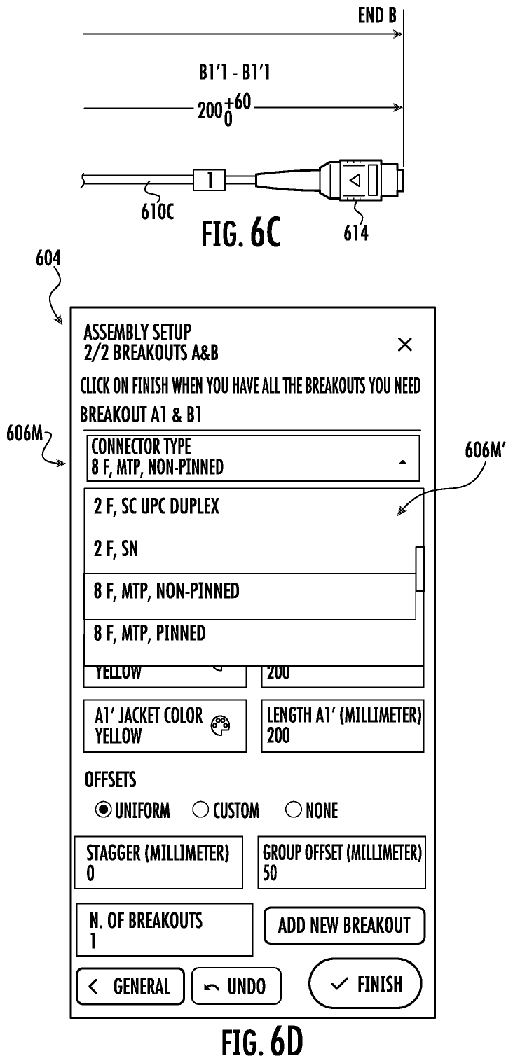

Looking first at FIG. 1E, a label 116 may be provided for each leg cable 110C, and a label 120 may be provided for each breakout cable 110B. These labels may be altered in the cable properties portion 104 (see FIGS. 1B and 1C) and/or the tabular display portion 425 (see FIG. 4B) in some embodiments. While the label 116 and the label 120 simply provide numbers that may be used to identify the cable, labels may be edited to include text (see, e.g., FIG. 5), symbols, or other material in other embodiments.

Turning now to FIG. 1D, a fiber utilization counter 108 may be provided in the cable illustration portion 102 or in some other portion presented on the display 100 (see FIG. 1A). The fiber utilization counter 108 may serve as an overutilization indication in some embodiments to indicate that a user-customized cable overutilizes end fibers where overutilization has occurred. However, the fiber utilization counter 108 may also serve as an allowable utilization indication to indication that the user-customized cable underutilizes the end fibers or that the user-customized cable utilizes each of the end fibers without overutilization where overutilization has not occurred. In the illustrated embodiment of FIG. 1D, the fiber utilization counter 108 states “64/72/64” in green text. This may indicate that there are 64 end fibers represented on the first end of the user-customized cable on the left, an available fiber count set at 72, and 64 end fibers represented on the second end of the user-customized cable on the right. On each end of the user-customized cable illustrated in FIG. 1D, there are two end fibers associated with each connector 114 (see FIG. 1E) and with each leg cable 110C, there are sixteen end fibers associated with each breakout cable 110B, and there are consequently 64 end fibers associated with the primary cable. Green text may be used as shown in FIG. 1D to indicate that overutilization has not occurred, but indications may be made to show that no overutilization has occurred in other ways. For example, a signal may be sent having the indicator; the current number of end fibers may be presented on a display 100 (see FIG. 1A); a number of end fibers associated with a representation of a subunit cable may be presented on the display 100; a symbol that indicates the current number of end fibers may be presented on the display 100; or an item may be presented on the display 100 in a first color.

Furthermore, upon determining that overutilization has occurred, a recommendation indication may be provided to the user of a new available fiber count for the primary cable that does not result in overutilization in some embodiments. For example, where the available fiber count is initially set at a count of seventy two end fibers and the current number of end fibers is between seventy three end fibers and ninety six end fibers, a recommendation indication may be presented to the user suggesting a new available fiber count of ninety six end fibers. Alternatively, upon determining that overutilization has occurred, the available fiber count may be increased automatically.

In some embodiments, an indication may be provided to inform the user that overutilization has not occurred (e.g. that the fibers are underutilized or used without overutilization). However, in some embodiments, a specific determination may be made to determine whether the available fiber count is equal to the current number of end fibers, and an indication may be provided that the user-customized cable utilizes each of the end fibers without overutilization if the available fiber count is equal to the current number of end fibers. Additionally, in some embodiments, a specific determination may be made to determine whether the available fiber count is greater than the current number of end fibers, and an indication may be provided that the user-customized cable underutilizes the end fibers without overutilization if the available fiber count is greater than the current number of end fibers. Different colors (e.g. green, yellow, red, etc.) may be used to show overutilization, underutilization, or full utilization, or indications may be provided in other ways.

In some embodiments, the user-customized cable may be initially provided with one breakout cable and one leg cable on each end, and users may progressively add more breakout cables, leg cables, and/or additional cables. FIG. 2A illustrates a cable illustration portion 202 with a user-customized cable that may be initially presented. As illustrated, the user-customized cable may include a primary cable having one first primary cable segment 210A towards the first end of the user-customized cable and one second primary cable segment 210A′ towards the second end of the user-customized cable. The user-customized cable may also include one breakout cable 210B towards the first end of the user-customized cable and one breakout cable 210B′ towards the second end of the user-customized cable. The user-customized cable may also include one leg cable 210C having a connector 214 towards the first end of the user-customized cable and one leg cable 210C′ having a connector 214′ towards the second end of the user-customized cable. Further, the cable illustration portion 202 illustrated in FIG. 2A may include a fiber utilization counter 208. The fiber utilization counter 208 states “2/72/2” in green text in the illustrated embodiment of FIG. 2A, representing that there are currently two end fibers represented on the first end of the user-customized cable on the left, an available fiber count set at 72, and two end fibers represented on the second end of the user-customized cable on the right. In this illustrated embodiment, overutilization is not occurring as the number of end fibers on each end is less than the available fiber count.

By contrast, FIG. 2B illustrates a cable illustration portion 202 with a representation of a user-customized cable where overutilization is occurring. The fiber utilization counter 208 of FIG. 2B states “80/72/80,” with the first number and third number presented in red text and with the second number presented in green text. This may represent that there are currently 80 end fibers represented on the first end of the user-customized cable on the left, an available fiber count set at 72, and 80 end fibers represented on the second end of the user-customized cable on the right. By presenting the first and third numbers in red text, the fiber utilization counter 208 may indicate that overutilization is occurring, and this may alert the user to make changes to address this issue. A user may do this by increasing the available fiber count (e.g. by changing the available fiber count from 72 to 96) or by decreasing the number of end fibers on the relevant end of the user-customized cable. The number of end fibers on an end of the user-customized cable may be adjusted in several ways. For example, the number of end fibers may be adjusted by changing the connector type for some or all of the connectors 214, by changing the number of leg cables 210C in breakout cables 210B, or by changing the number of breakout cables 210B. The red text may indicate that overutilization has occurred, but indications may be made to show that overutilization has occurred in other ways. For example, a signal may be sent having the indicator; the current number of end fibers may be presented on a display 100 (see FIG. 1A); a number of end fibers associated with a representation of a subunit cable may be presented on the display 100; a symbol that indicates the current number of end fibers may be presented on the display 100; or an item may be presented on the display 100 in a first color.

The footprint of the cable representation may be maximized in the cable illustration portion 202 so that certain features within the cable representation may be more easily identified. FIG. 2B illustrates one example of this. In FIG. 2B, the cable representation has a first end (shown as END A in FIG. 2B) and a second end (shown as END B in FIG. 2B). Additionally, the cable illustration portion 202 may include a first edge (e.g. on the left side) and a second edge (e.g. on the right side). A longest represented cable on the first end may extend proximate to the first edge of the cable illustration portion, and a longest represented cable on the second end may extend proximate to the second edge of the cable illustration portion. In this way, the footprint of the cable representation extend the full length in the cable illustration portion from left to right. Additionally, representations of subunit cables (e.g. 210B and 210C) may be spaced apart vertically in the cable illustration portion so that features of the cable representation may be more easily identified.

Additionally, in some embodiments, a cable number may be provided for each primary cable, breakout cable, leg cable, etc. For example, in FIG. 2B, the breakout cables 210B on the first end have cable numbers ranging from A1-A5, and breakout cables 210B′ on the second end have cable numbers ranging from B1-B5. Additionally, the leg cables 210C associated with a first breakout cable on the first end may have cable numbers ranging from A1′1-A1′8, and similar cable numbers may be used for other breakout cables on the first end (e.g. A2′1-A2′8, A3′1-A3′8, A4′1-A4′8, A5′1-A5′8). The leg cables 210C′ associated with a first breakout cable on the second end may have cable numbers ranging from B1′1-B1′8, and similar cable numbers may be used for other breakout cables on the second end (e.g. B2′1-B2′8, B3′1-B3′8, B4′1-B4′8, B5′1-B5′8). The primary cable representation may have a first primary cable segment 210A on the first end, and this may have the cable number A0. Similarly, the primary cable representation may have a second primary cable segment 210A′ on the second end, and this may have the cable number B0. While the cable illustration portion 202 in FIG. 2B does not include length information for the cables, this information may be included in some embodiments (see, e.g., FIG. 3A).

In some embodiments, where an asymmetrical mode is used, the number of end fibers at the first end may differ from the number of end fibers at the second end. FIG. 2C illustrates an example of a cable illustration portion 202 including a representation of such a user-customized cable. The fiber utilization counter 208 of FIG. 2C states “80/72/2,” with the first number presented in red text and with the second and third numbers presented in green text. The asymmetrical mode may be selected at field 106A (see FIG. 1B) in the cable properties portion 104. Where an asymmetrical mode is used, properties may be first received for each of the breakout cables 210B and leg cables 210C on the first end before progressing to properties for each of the breakout cables 210B′ and leg cables 210C′ on the second end. Alternatively, properties may be received for only a portion of breakout cables 210B and/or associated leg cables 210C on the first end and then properties may be received for associated breakout cables 210B′ and/or associated leg cables 210C′ on the second end. The example of FIG. 2C illustrates that the first end and second end of a user-customized cable may be independently modified, and it may be commercially unfeasible to manufacture some cable variations. For example, it may not be commercially feasible to manufacture a user-customized cable with 80 end fibers on a first end and 2 end fibers on the second end, and additional end fibers may need to be added on the second end.

FIG. 3A illustrates an enhanced view of a cable illustration portion where leg cables 310C have staggered length values and where organized length measurements are presented. In the illustrated embodiment, there are eight leg cables 310C provided within one breakout cable 310B. Four of the leg cables 310C are provided in a first group 312A and another four of the leg cables 310C are provided in a second group 312B. Connectors 314 are provided for each of the leg cables 310C.

One improvement provided by various embodiments herein is an improved approach for presenting length measurements of cable representations, and FIG. 3A illustrates an example of this. A length measurement segment 320 and an actual length measurement value 320′ for the breakout cable 310B may be provided. The length measurement value 320′ and other similar values may include a length value as well as relevant tolerances for that length value. Further, a representation of a first leg cable 310C is provided at the top of FIG. 3A, and a representation of a second leg cable 310C is provided just below the first leg cable. A first length measurement segment 322A for a first leg cable 310C is presented, and an actual length measurement value 322A′ may be provided alongside the first length measurement segment 322A. The first length measurement segment 322A may extend from a proximate end of the length measurement segment 320 to the end of the representation of the first leg cable 310C. Additionally, a second length measurement segment 322B for a second leg cable 310C may be provided, and an actual length measurement value 322B′ may also be provided alongside the second length measurement segment 322B. The second length measurement segment 322B may extend from a proximate end of the first length measurement segment 322A to the end of the representation of the second leg cable 310C.

Additional length measurement segments may be presented in a similar manner. For example, a length measurement segment 322C for a fifth leg cable 310C may be provided, and an actual length measurement value 322C′ may also be provided alongside the length measurement segment 322C. The length measurement segment 322C may extend from a proximate end of the previous length measurement segment to the end of the fifth leg cable representation. Further, a length measurement segment 322D for an eighth and final leg cable 310C may be provided, and an actual length measurement value 322D′ may also be provided alongside the length measurement segment 322D. The length measurement segment 322D may extend from a proximate end of the previous length measurement segment to the end of the eighth leg cable representation.

The approach for presenting length measurement segments and length measurement values may be advantageous over other approaches. FIG. 3B is an enhanced view illustrating another approach for representing length measurements having increased clutter. As illustrated, the length measurement segments 324 may extend for the entire length of each of the leg cables 310C. Notably, the relative length representations have a same length display ratio such that there is little space to show the connectors 314 between adjacent cables, and a vast distance of cable is shown with little important information being presented. This results in increased clutter within the image. When the number of illustrated leg cables reaches a substantial number (see, e.g., FIG. 2B), this more cluttered approach may significantly increase the difficulty for users in reading and deciphering length information. Additionally, as a result of this clutter, more space is devoted to presentation of the length information and less space may be available for the presentation of the user-customized cable itself. Thus, the more cluttered approach of FIG. 3B may make the representation of the user-customized cable and the specific features of the user-customized cable less easy to understand.

By presenting the length information as illustrated in FIG. 3A, the size of the user-customized cable representation may be maximized in the cable illustration portion 202 (see FIG. 2B). Further, length information may still be presented in a compact and easily understandable format. By presenting the length information as illustrated in FIG. 3A, user-customized cables having large numbers of breakout cables and/or leg cables may be illustrated in the cable illustration portion 202 in a readily understandable manner while still showing all the cable features on one display screen.

In some embodiments, a specific breakout cable or a specific leg cable when the properties for that cable are being adjusted may be emphasized. As used in this disclosure, an item is “emphasized” when it is presented in a distinguishable manner from other similar items. FIG. 4A illustrates an example of such an embodiment, with an enhanced view illustrating a cable illustration portion where a breakout cable 410B and leg cables 410C therein are selected and emphasized through highlighting. Here, the top breakout cable 410B and leg cables 410C are highlighted in cross hatching, but other emphasis techniques may be used (e.g., colors, highlights, bolding, enlargement, etc.). Furthermore, these cables may be emphasized in other ways as well. For example, text, numbers, or symbols may be provided to emphasize certain cables, other cables may be hidden, an outline box may be provided around certain cables to emphasize them, etc. Emphasis of a breakout cable and/or leg cables in the cable illustration portion 102 (see FIG. 1D) may occur as a result of selection of a cable in the cable properties portion 104 (see FIGS. 1B and 1C), as a result of selection of a cable in the tabular display portion 425 (see FIG. 4B), as a result of selection in the cable illustration portion 102 itself, or based on selection through another approach.

FIG. 4B illustrates a tabular display portion 425 having a table with editable properties for the user-customized cable. Breakout cable selections 426 may be provided in the tabular display portion 425, and these breakout cable selections 426 may be configured to permit the user to select a breakout cable that they wish to edit the properties of. In the illustrated embodiment, a breakout cable B1 is selected and the properties of this breakout cable B1 are presented. Field 428A may provide a designated number or label for the connector or leg cable, and field 428B may provide a designated number or label for the group that a leg cable is in. These designated numbers or labels may also be presented in the cable illustration portion 102 (see FIG. 1D). Additionally, fields 434 permit the user to quickly select one or more leg cables that the user wishes to make adjustments for, and adjustments inputted for one of these leg cables may be applied for each of the selected leg cables.

Field 430A, field 430B, and field 430C may receive additional properties for each of the leg cables within the breakout cable. Field 430A may receive a color for the connector associated with the leg cable. Field 430B may receive a label for the leg cable in the form of a number, text, a symbol, etc. Additionally, field 430C may receive a color for a label of a leg cable.

Field 432A, field 432B, and field 432C may present length information for the various leg cables within the breakout cable. Field 432A may present the actual length of the breakout cable B1, field 432B may present the actual length for each of the leg cables, and field 432C may present the combined length of the lengths presented in field 432A and field 432B.

In some embodiments, the tabular display portion 425 may permit some or all of the fields to be selected and altered. This permits quick and easy alterations to the user-customized cable, and this permits the user-customized cable to be tailored to meet the precise needs desired by the user. For example, FIG. 4D illustrates a tabular display portion 425 where the user has made changes at field 430A, field 430B, and field 430C. In this example, the first leg cable of the first group has field 430A changed so that an orange connector color is used, has field 430B changed so that the label reads “Label12345”, and has field 430C changed so that the label color is rose. As illustrated, in FIG. 4C, the changes made in the tabular display portion 425 may be simultaneously implemented in the cable illustration portion, with the label text, the label color, and the connector color of the first leg cable of the first group being altered.

However, in other embodiments, tabular display portion 425 may simply present the information in some or all of the fields without permitting further adjustments. For example, the field 432C (see FIG. 4B) may simply present the combined length without permitting direct adjustments at the field.

The properties set for the breakout cable B1 may be reflected in the cable illustration portion 102 (see FIG. 1D), and, in some embodiments, changes in properties in the tabular display portion 425 result in simultaneous changes in the cable illustration portion 102 (see FIG. 1D). FIG. 4A illustrates a cable illustration portion showing a representation of the user-customized cable having the cable properties of the tabular display portion 425 of FIG. 4B.

The tabular display portion 425 may provide several benefits. In some embodiments, the tabular display portion 425 may be presented simultaneously with the cable illustration portion 102 (see FIG. 1D). Thus, properties may be listed in the tabular display portion 425 in one area on the display while the cable illustration portion 102 may be presented in another area on the display, providing the information to a user in different formats so that the properties of the user-customized cable may be more easily understood. Further, in some embodiments, the cable properties portion 104 may be used first to quickly and easily set the cable properties for a large number of breakout cables and/or leg cables at once, and then the tabular display portion 425 may be subsequently used to adjust cable properties for individual breakout cables or leg cables. This may permit the user-customized cable to be adjusted in a quick and efficient manner while still permitting users to customize each breakout cable and/or leg cable as desired. The tabular display portion 425 may be presented on the display 100 by using the selection menu 105 (see FIG. 1A) in some embodiments.

Additionally, the cable illustration portion may also represent cables within a user-customized cable based on the relative length of the cables rather than the actual length of the cables. FIG. 5 is an enhanced view illustrating a cable illustration portion with a representation of a breakout cable and leg cables therein where representations of cables are presented based on relative lengths of the cables and where the relative lengths are not proportionate to the actual length of cables in the user-customized cable. Similar to other embodiments described herein, FIG. 5 illustrates a representation of a breakout cable and eight leg cables therein. Three of the leg cables extend a first actual length of 200 millimeters, one of the leg cables extends a second actual length of 205 millimeters, and the other four leg cables extend a third actual length 250 millimeters. While the difference between the third actual length and the second actual length (45 millimeters) is much greater than the difference between the second actual length and the first actual length (5 millimeters) the length of the cable representations on the display may show the cables spaced out in equal increments. This allows for more easily discerning the connectors and labels within the image and utilizes a greater amount of white space on the display, maximizing the visual footprint of the cable representation.

FIG. 5 illustrates a representation of a first breakout cable having a first leg cable with a first actual length 522A′ of 200 millimeters, a second leg cable having a second actual length 522B′ of 205 millimeters, and a third leg cable having a third actual length 522C′ of 250 millimeters.

The cables may be represented on the display based on relative lengths where the relative lengths of representations on the display are not proportional to the actual lengths of cables. For example, as illustrated in FIG. 5, a representation of the first leg cable on the display may have a first represented length 522A (e.g. ˜ 70 mm on the display), and a representation of the second leg cable on the display may have a second represented length 522B (e.g. 105 mm on the display). A first proportion value may be the first actual length 522A′ of the first leg cable divided by the first represented length 522A, and a second proportion value may be the second actual length 522B′ of the second leg cable divided by the second represented length 522B. The first proportion value and the second proportion value are not equal in some instances.

Furthermore, in some embodiments, the first difference between the first actual length (200 mm) and the second actual length (205 mm) may be 5 mm, and the second difference between the second actual length (205 mm) and the third actual length (250 mm) may be 45 mm. Thus, the first difference (5 mm) is not equal to the second difference (45 mm). However, the representations of the leg cables in the cable illustration portion may be presented so that the first represented difference and the second represented difference appear to be equal. For example, a representation of the first leg cable on the display may have a first representation length (e.g., first represented length 522A), a representation of the second leg cable on the display may have a second representation length (e.g., second represented length 522B), and a representation of the third leg cable on the display may have a third representation length (e.g., third represented length 522C). Further, the first representation difference between the first representation length and the second representation length may be equal to the second representation difference between the second representation length and the third represented length.

The use of relative lengths may be beneficial for several reasons. First, if actual lengths are used, this may tend to unnecessarily consume a large amount of space in the cable illustration portion. For example, if the length of the longest leg cables are substantially longer than other leg cables (e.g. 1000 mm), then a proportional representation on the display would greatly increase the length of the represented user-customized cable, and this would force the cable illustration portion to shrink other features so that the user-customized cable representation can fit in the cable illustration portion. By contrast, using relative proportionate lengths (e.g., the proportions may vary) may present the representation of the user-customized cable in a more compact manner, allowing the representation of the user-customized cable to be maximized in the cable illustration portion. Second, where actual proportionate lengths are used, smaller differences in lengths of cables may be much more difficult for users to identify. For example, if the length of leg cables are 200 mm, 205 mm, and 1000 mm, the user may not be able to identify a difference in the length of the 200 mm leg cables and the 205 mm leg cables. By presenting the cable representations based on relative lengths, users can more easily identify these subtle differences.

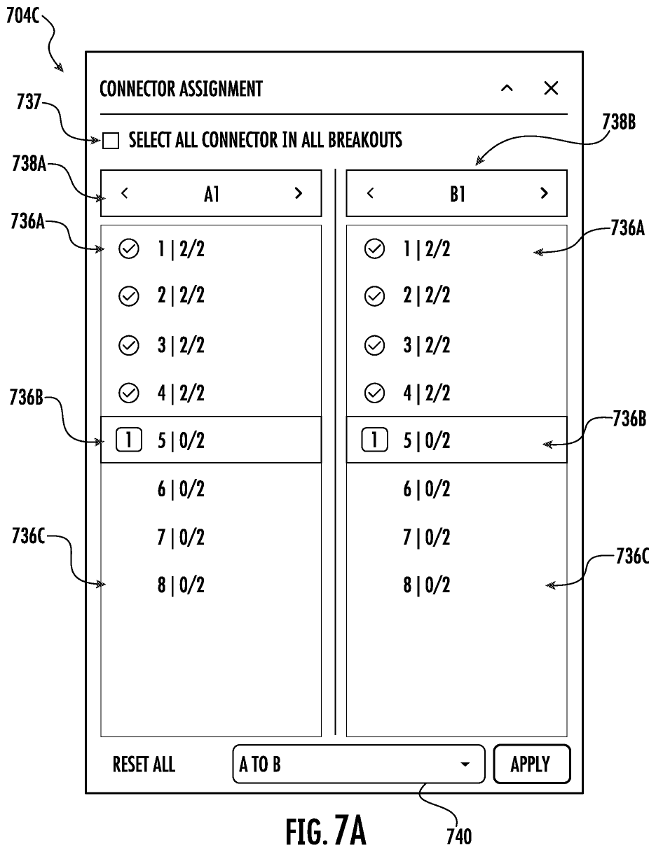

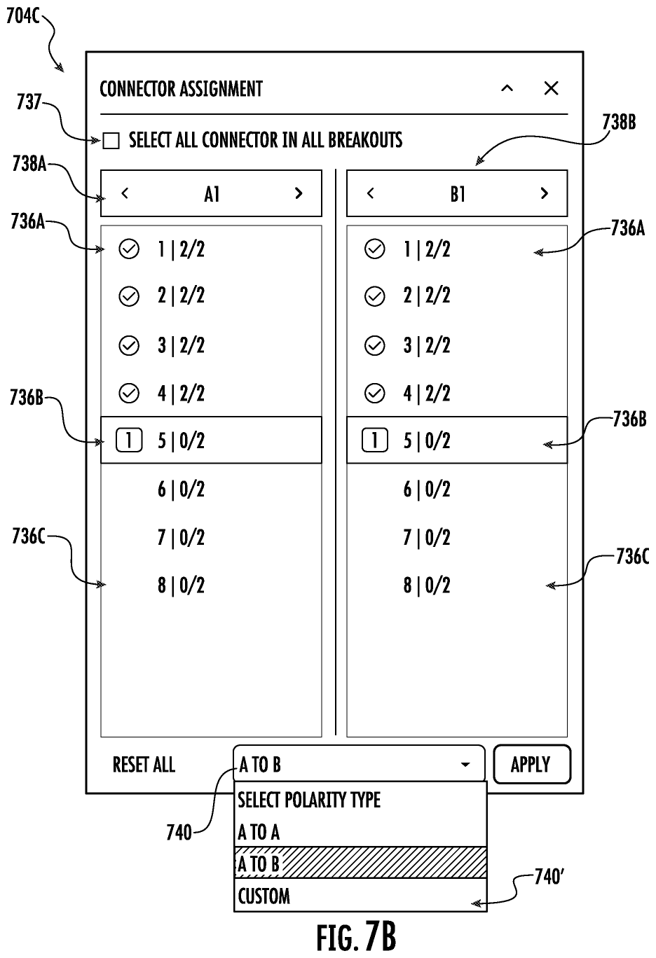

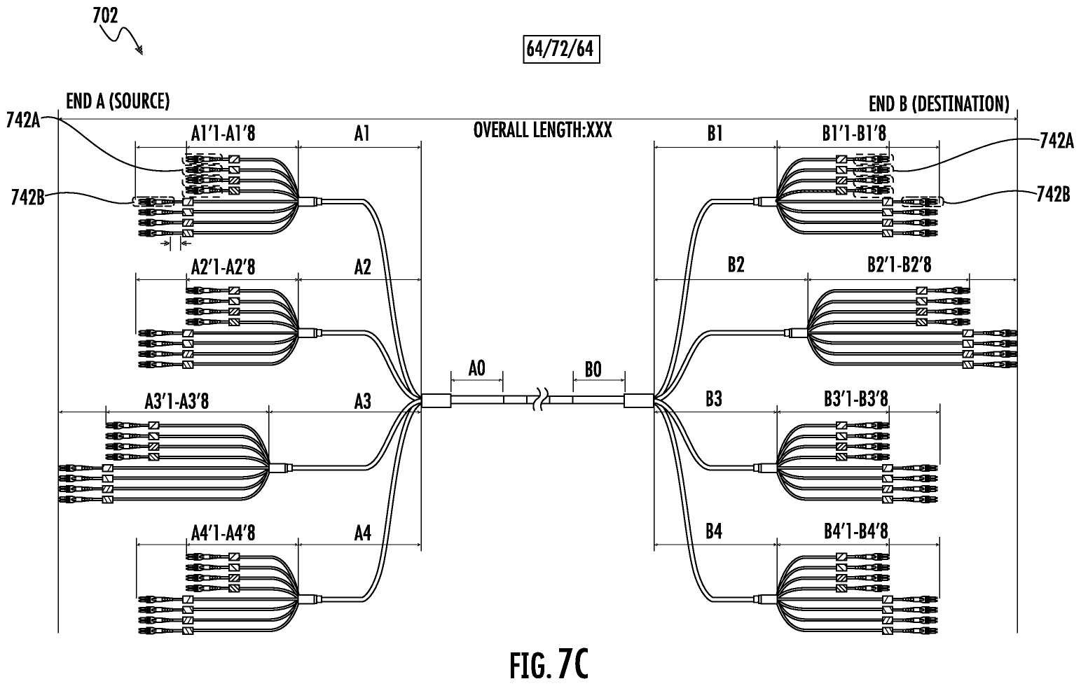

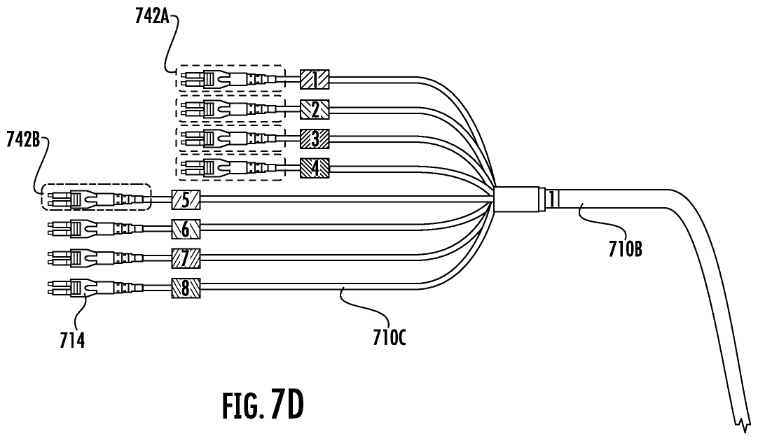

FIG. 7A illustrates a polarity assignment portion 704C where available polarity assignments may be selected for connectors. The field 738A may permit the selection of a desired breakout cable on a first end of the user-customized cable, and field 738B may permit the selection of a desired breakout cable on a second end. By selecting a desired breakout cable, polarity assignment information may be presented for that breakout cable. In some embodiments, the selection of a desired breakout cable on the first end (e.g. breakout cable A1) automatically causes information for a corresponding breakout cable (e.g. breakout cable B1) on the second end to be presented.

Various polarity assignment items 736A, 736B, 736C may be presented in the polarity assignment portion 704C. The polarity assignment items 736A may indicate that a polarity assignment has been completed. The polarity assignment items 736B may indicate that a polarity assignment is actively being made and/or that the corresponding connector has been selected. Further, polarity assignment items 736C may indicate that a polarity assignment has not yet been made.

Polarity assignment items may be provided in a variety of ways. For example, in FIG. 7A, the polarity assignment item 736A is presented as a green check mark, the polarity assignment item 736B is presented in an orange square, and the polarity assignment item 736C is provided by omitting any emphasis. However, the polarity assignment items may be provided in other ways. For example, an actual polarity assignment may be listed (e.g. A to B, A to A, a new custom assignment, a saved custom assignment, etc.), the text may be highlighted, different symbols may be used, etc.

In some embodiments, the polarity assignments may be input one by one, and the user can customize each polarity assignment as desired. In other embodiments, the user may select multiple polarity assignment items at once, and polarity assignments may be made for each of the connectors corresponding to these polarity assignment items at the same time. Additionally, users may simply select field 737 to select all of the polarity assignment items for a breakout, and the same polarity assignment may be made for each of the connectors corresponding to the polarity assignment items. Once a polarity assignment item has been selected, the user may select the field 740. Selection of the field 740 may cause a drop-down menu 740′ to be presented, and the user may select a polarity assignment from the drop-down menu 740′.

To assist the user in making polarity assignments, a cable illustration portion 102 (see FIG. 1D) may be presented on the display 100 (see FIG. 1A) simultaneously with the polarity assignment portion 704C. An example of such a cable illustration portion 702 is illustrated in FIG. 7C. Furthermore, an enhanced view of this cable illustration portion 702 is illustrated in FIG. 7D, with a breakout cable 710B and eight leg cables 710C being illustrated. The cable illustration portion 702 is similar to the cable illustration portion 102 of FIG. 1D in many respects. However, in the cable illustration portion 702 of FIGS. 7C and 7D, emphasis may be used to effectively reveal whether a polarity assignment has been made for each of the connectors 714.

An indicator 742A may be used to show that a polarity assignment has been made for a connector 714. In the illustrated embodiment, the indicator 742A is provided by making a green outline around connectors 714. An indicator 742B may be used to show one or more connectors 714 for which an assignment is currently being made. In the illustrated embodiment, the indicator 742B is provided by making an orange outline around a connector 714 and by highlighting the area within the outline in orange. If no indicator 742A or indicator 742B is illustrated for a connector 714, then this may effectively indicate that an assignment has not been made for the connector 714. The indicator 742A and 742B may be provided in other forms in different embodiments. For example, text may be presented beside the representations of connectors to indicate their polarity assignment status, highlighting may be used, symbols or numbers may be presented beside the representations of connectors, different colors may be used for text or highlighting, etc. Additionally, while connectors not having a polarity assignment do not have any markings to indicate the lack of a polarity assignment, markings may be used in some embodiments to indicate this.

Furthermore, in some embodiments, a number of successful polarity assignments may be presented. The number of successful polarity assignments may be presented alongside the available fiber count in some embodiments, and this may permit the user to visualize his or her progress in making assignments.

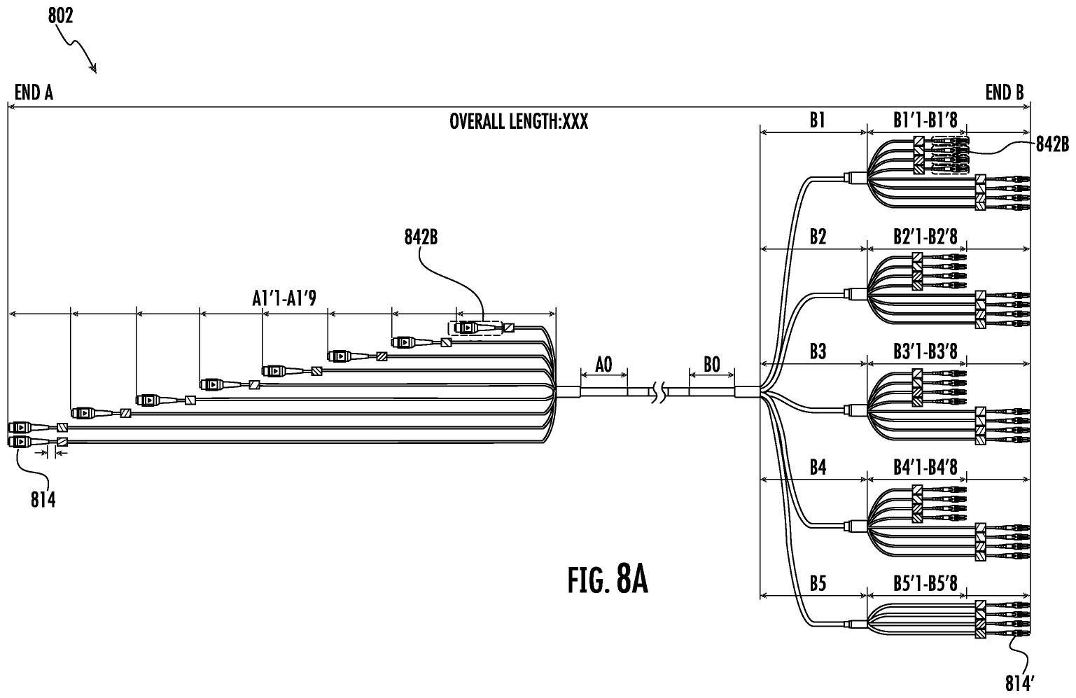

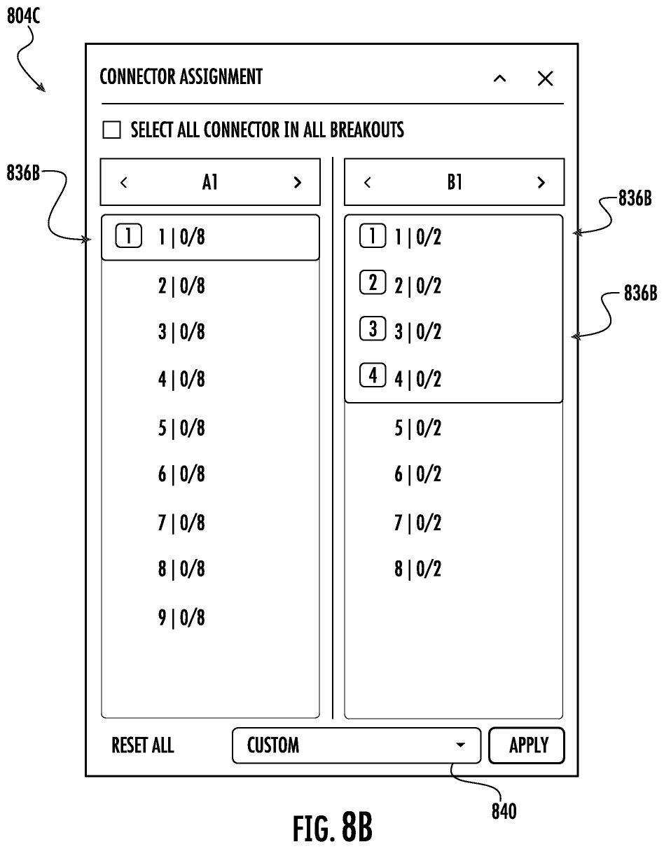

While the embodiments in FIGS. 7A-7D use the same connector types for connectors on the first end and second end of the user-customized cable, other embodiments may use different connector types for connectors on the first end and the second end. FIGS. 8A-8B illustrate examples of this. In FIG. 8A, an eight-fiber, MPO, non-pinned connector type may be used for each of the connectors 814 on a first end (e.g. on the left side) of the user-customized cable in the cable illustration portion 802. Further, a two-fiber, LC Uniboot connector type may be used for each of the connectors 814′ on a second end (e.g. on the right side) of the user-customized cable in the cable illustration portion 802. Thus, for each connector 814 on the first end, there may be four corresponding connectors 814′ on the second end. When a connector 814 is selected in some way, an indicator 842B may be provided for the connector 814 and for the corresponding connectors 814′. By doing so, the user may be better able to visualize the fiber mapping within the user-customized cable. This emphasis approach may be used when inputting polarity assignments, but it may also be used when making other adjustments to the user-customized cable.

Additionally, a polarity assignment portion 804C may be provided as illustrated in FIG. 8B. The polarity assignment portion 804C of FIG. 8B may be similar to the polarity assignment portion 704C of FIG. 7B in many respects. The polarity assignment portion 804C may present polarity assignment items 836B for connectors that are currently being assigned a polarity assignment. The polarity assignment items 836B may correspond to a representation of a connector 814 or a representation of a connector 814′ in the cable illustration portion 802 of FIG. 8A. In some embodiments, selection of a representation of a connector 814, a representation of a corresponding connector 814′, or a corresponding polarity assignment item 836B in FIG. 8B may cause each of the representation of the connector 814, the representation of the corresponding connector 814′, and the corresponding polarity assignment item 836B to be emphasized as shown. This may permit the user to easily identify relevant material so that the user may make quick and informed decisions. This may also tend to minimize user-error.

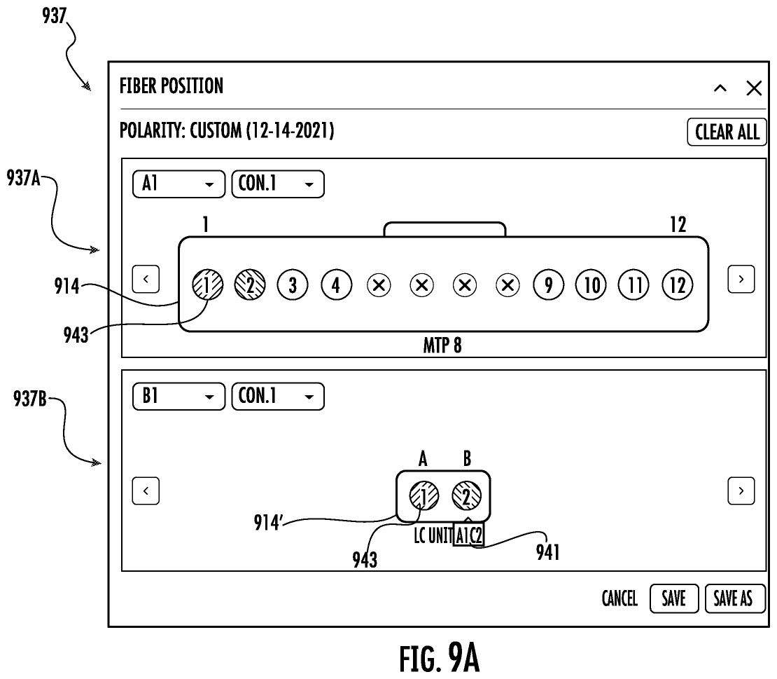

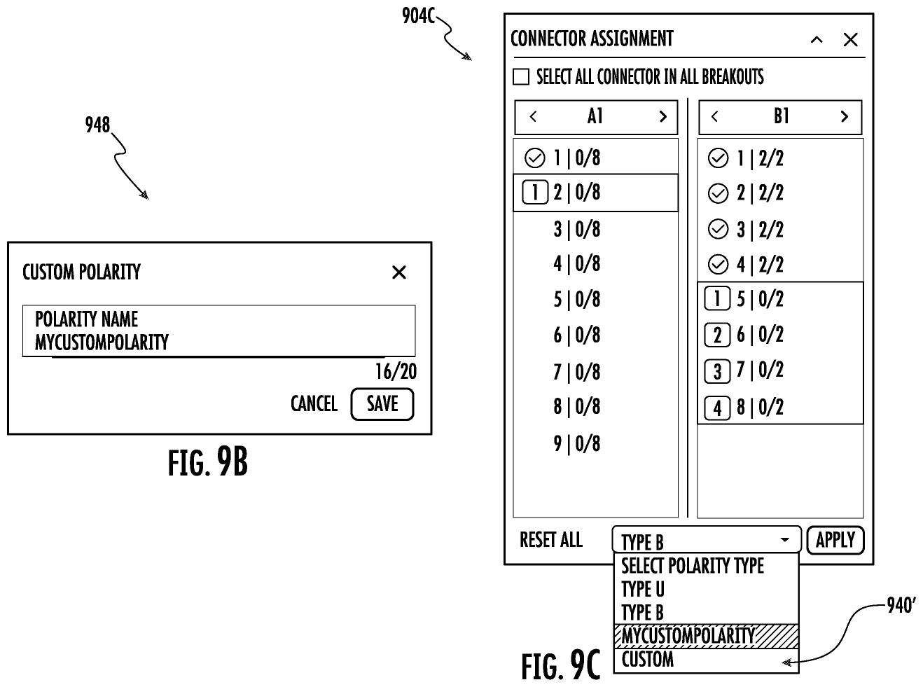

Furthermore, FIG. 8B shows that the user has selected a custom polarity assignment in field 840. After making this selection, a custom polarity assignment portion 937 may be presented on the display 100 (see FIG. 1A) as illustrated in FIG. 9A. This custom polarity assignment portion 937 may include a first section 937A and a second section 937B. The first section 937A may present information related to a connector 914 on a first end of the user-customized cable, and the second section 937B may present information related to a corresponding connector 914′ on a second end of the user-customized cable. The first section 937A may show various end fibers 943 within the connector 914, and the second section 937B may show how these end fibers 943 are mapped to the corresponding connector 914′. In the illustrated embodiment, a first end fiber 943 may be illustrated in a first color (e.g. blue) and may be in the first position of the connector 914. This first position is presented as a circle on the far left side of the connector 914. A user may select the position where this fiber extends to in a corresponding connector 914′ on the second end of the user-customized cable. Once the appropriate corresponding connector 914′ has been selected so that it appears in the second section 937B, the user may select a corresponding position for the first end fiber 943 in the corresponding connector 914′. In the illustrated embodiment, the user has selected the first position on the illustrated corresponding connector 914′, and this first position is presented as a circle on the far left side of the corresponding connector 914′. Once an end fiber has been successfully mapped from one connector to another connector, the custom polarity assignment portion 937 may highlight the circle in a color (e.g. blue). This process may be completed to map other end fibers from a connector 914 on a first end of the user-customized cable to other corresponding connectors 914′ on the second end. In some embodiments, each end fiber in the connector 914 may have a different color designation (e.g. blue, orange, green, brown, etc.), and this may enable easy visualization of the fiber mapping for users.

Additionally, in some embodiments, a user may hover over an end fiber represented in the first section 937A or the second section 937B, and this may reveal where that end fiber is routed to at the opposite end. For example, in FIG. 9A, the user may have the mouse over the second end fiber illustrated in the second section 937B, and this may cause information to be presented about where this end fiber is routed to at the first end of the user-customized cable. For example, text 941 is presented in FIG. 9A, stating “A1C2” to indicate that the end fiber is routed to a connector for a first breakout cable and that the end fiber is at the second position in that connector.

Once the user has finished mapping the fibers in the custom polarity assignment portion 937, the user may save the polarity scheme in memory. By doing so, a pop-up screen 948 may be presented as illustrated in FIG. 9B. This pop-up screen 948 may permit the user to input a name for the custom polarity scheme, such as “MyCustomPolarity.” Once the desired name has been input, this name may be saved and associated with the polarity scheme in memory. Once saved, the drop-down menu 940′ may present the custom polarity scheme using the provided name, and the drop-down menu 940′ may also permit the user to create a new custom polarity scheme.

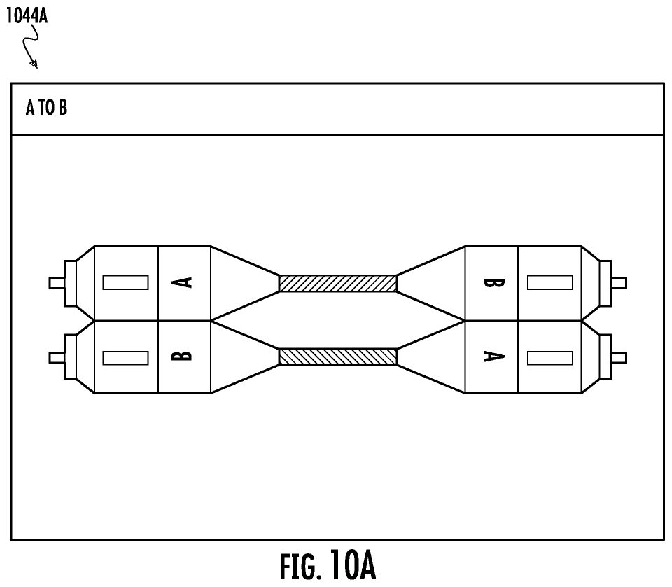

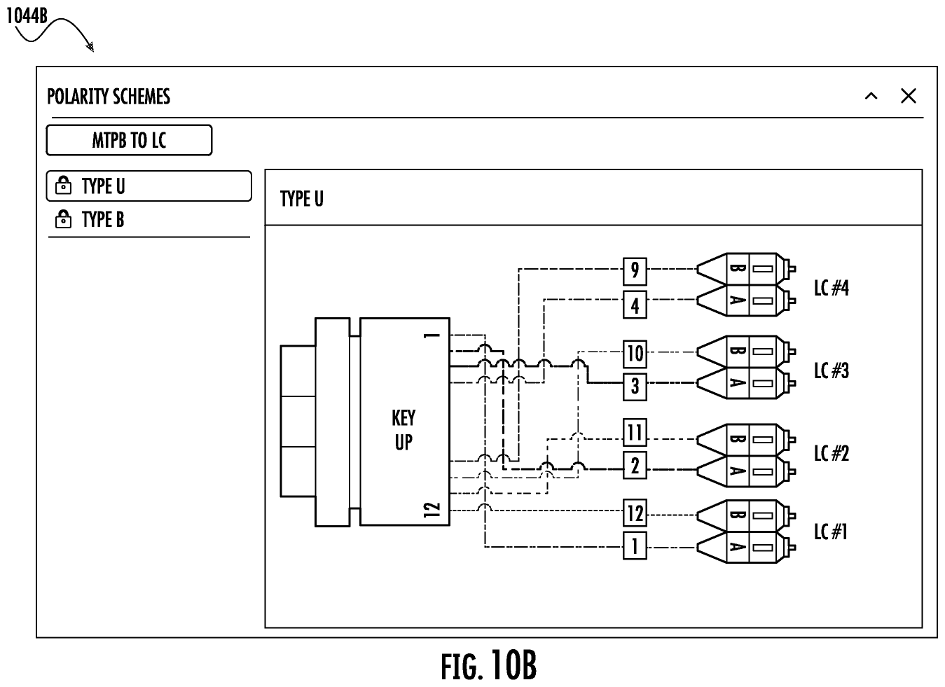

In some embodiments, further graphics or diagrams may be provided to the user to show the mapping of end fibers between connectors. Examples of this are illustrated in FIGS. 10A and 10B. In FIG. 10A, an A-to-B polarity scheme is illustrated in the polarity scheme display 1044A, with end fibers extending from a two-fiber connector on a first end to another two-fiber connector on the second end. In FIG. 10B, a type U polarity scheme is illustrated in the polarity scheme display 1044B, with end fibers extending from an eight-fiber MPO connector on a first end to four different two-fiber connectors on the second end. While an A-to-B polarity scheme and a type U polarity scheme are illustrated in FIGS. 10A and 10B respectively, other polarity schemes may also be presented. For example, an A-to-A polarity scheme, a type B polarity scheme, a custom polarity scheme, etc. may be presented in some embodiments.

The polarity scheme display 1044A and the polarity scheme display 1044B may illustrate the fiber mapping in another alternative approach so that users may more easily understand the current fiber mapping. This may permit the user to quickly identify errors and may make it easier for novice users to customize their user-customized cable as desired.

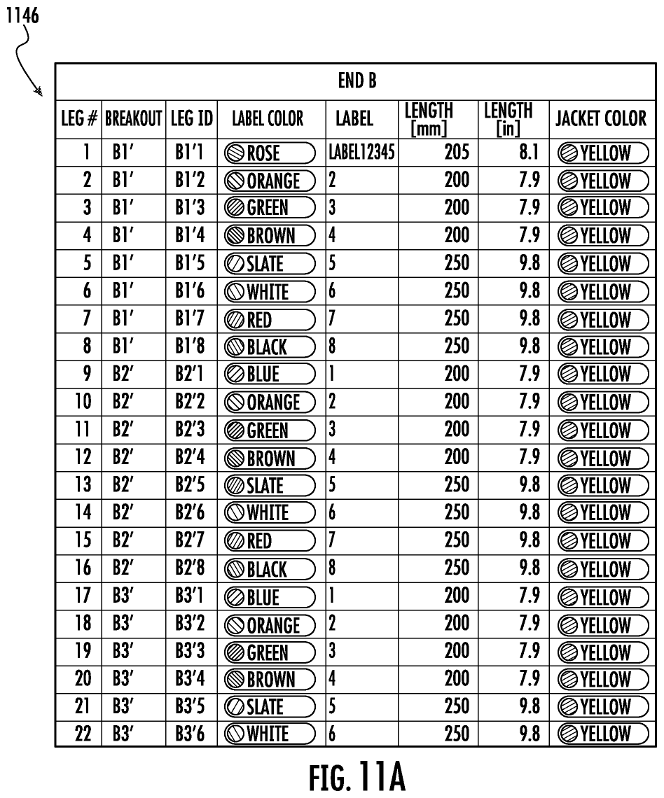

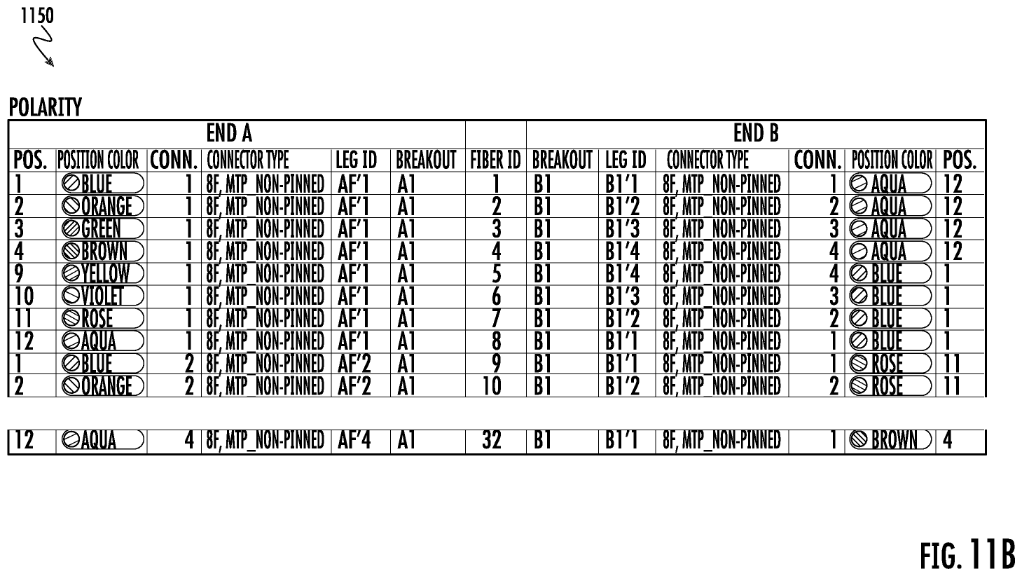

Additionally, in some embodiments, information regarding length information, polarity, and/or other features may be presented in a table to permit the user to visualize these properties in an alternative approach. FIGS. 11A and 11B illustrate a length customization table 1146 and a polarity customization table 1150 respectively.

In the length customization table 1146 of FIG. 11A, various numbers of leg cables are listed in the first column, and various properties are shown for each of these leg cables such as length information. There are 22 leg cables presented in the length customization table 1146. The second column shows a breakout that the leg cable is associated with, and the third column shows an identifier for the specific leg. For example, the first identifier shown is “B1′1,” and this indicates that the leg cable is the first leg cable associated with breakout cable B1′. As another example, the final identifier shown is “B3′6,” and this indicates that the leg cable is the sixth leg cable associated with breakout cable B3′. The fourth column may permit customization of the label color, and the fifth column may permit customization of the content on the label. Additionally, the sixth column may present the length of the leg cable in millimeters, and the seventh column may present the length of the leg cable in inches. The eighth and final column may present the jacket color for the leg cable.

Turning now to FIG. 11B, a polarity customization table 1150 is illustrated. The polarity customization table 1150 presents properties for a connector on the first end and a connector on the second end simultaneously, with the properties actually provided on the same line. This may permit users to quickly and easily identify potential adjustments, make adjustments to the polarity scheme, and/or to validate the polarity scheme.

The first column in the polarity customization table 1150 presents a specific position within a connector. In the illustrated embodiment, eight-fiber connectors are used on the first end and the second end, so the available connector positions that are listed include 1, 2, 3, 4, 9, 10, 11, and 12 (see FIG. 9A). The available connector positions may be different in other embodiments. In the second column, a designated color is provided for the position. Further, the third column illustrates an identifier for the connector, and the fourth column provides the connector type. The fifth column provides the leg ID (e.g. “A1′1” or “A1′4”), and the sixth column provides an identifier for the relevant breakout. The seventh column, which is in the center of the polarity customization table 1150, may indicate a fiber number for the fiber, with the numbers ascending from 1 to 32. The eighth column through the thirteenth column may then present the same information for the second end of the user-customized cable. In some embodiments, information for the second end of the user-customized cable may be presented on the left side of the polarity customization table 1150 and information for the first end of the user-customized cable may be presented on the right side of the polarity customization table 1150.

The polarity customization table 1150 may provide many benefits. The table 1150 may permit the user to ensure that an equal number of fibers are listed on the first end and the second end. Where this is not the case, the user has likely made an error that needs to be addressed. Thus, the table 1150 may permit easy identification of errors. Further, with properties for the two ends of individual fibers shown adjacent to each other, the table 1150 is provided in a manner that permits the user to quickly and easily confirm that fiber mapping is correct. For example, the pattern of position colors on the left side and the right side should be consistent, such that if the pattern is not, this may likely indicate that an error in the polarity assignment and/or cable formation occurred. Additionally, in some embodiments, the user may make changes directly within the table 1150 if desired.

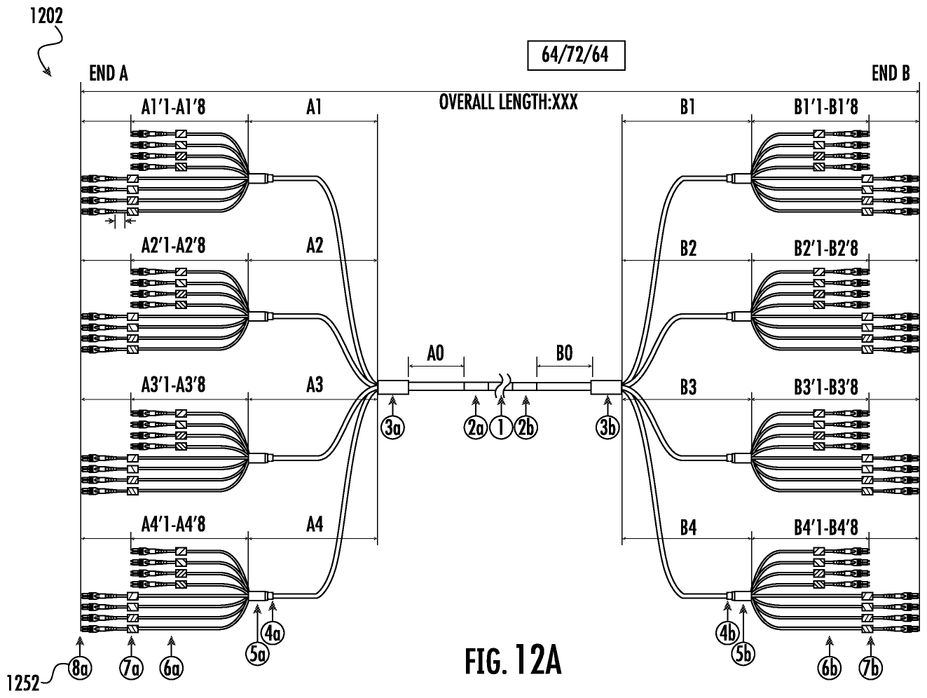

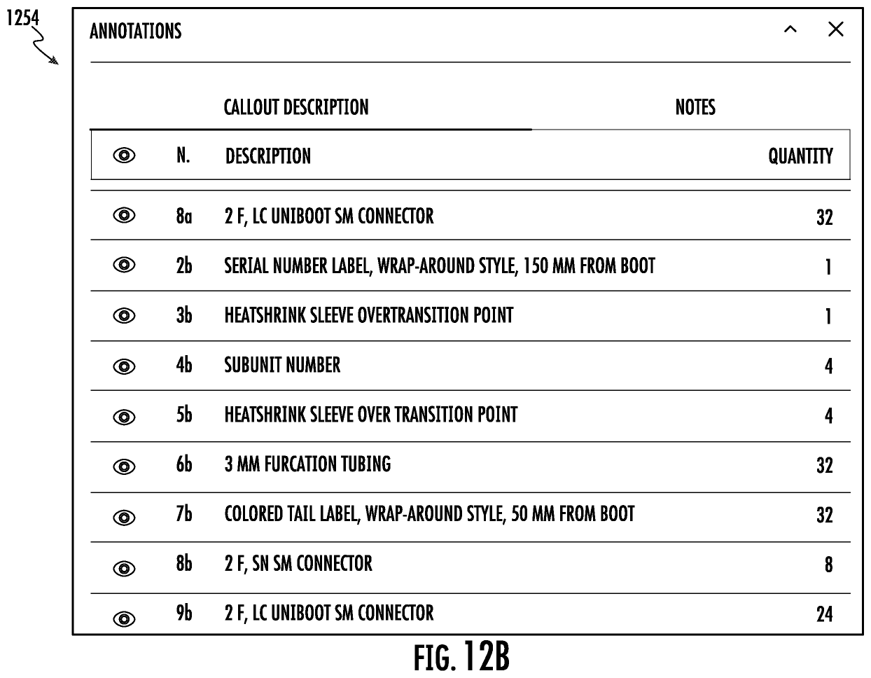

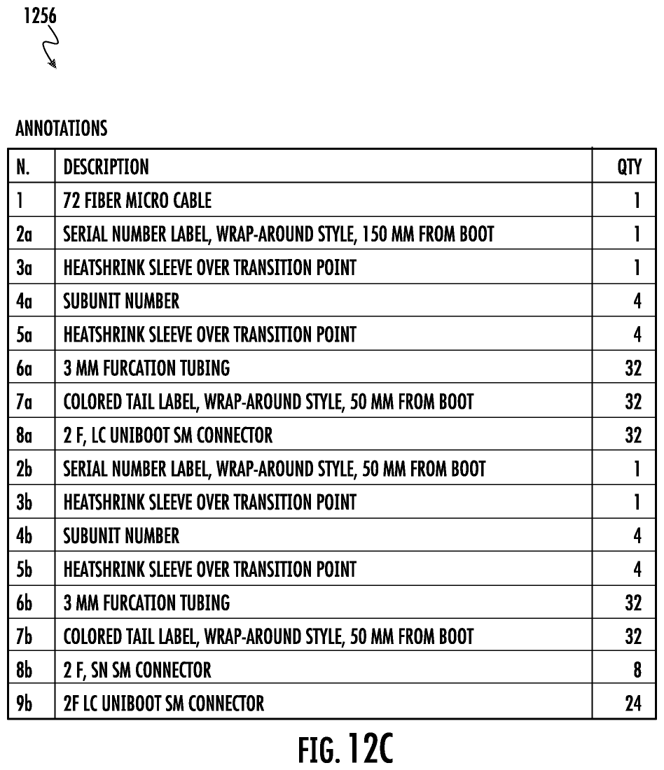

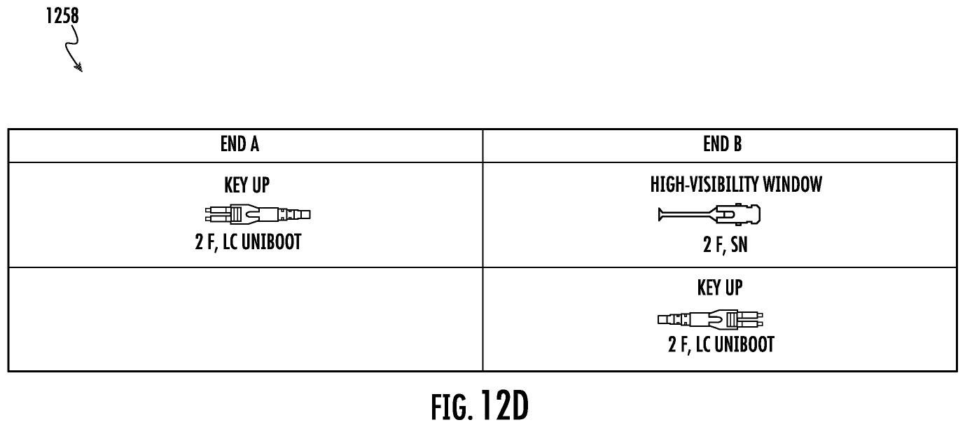

Additionally, the cable illustration portion may be used to create a bill of materials in some embodiments. FIG. 12A illustrates an example of a cable illustration portion 1202 being used to create a bill of materials. The cable illustration portion 1202 may include the representation of the user-customized cable. Further, labels 1252 may be provided for the various components in the user-customized cable. These labels 1252 may be provided as a number, text, a symbol, etc. In some embodiments, labels 1252 may be provided for automatically, and the user may add or delete labels 1252 as desired or the user may reposition the labels 1252. Labels 1252 may be provided automatically for each distinct component in the user-customized cable in some embodiments, or the cable illustration portion 1202 may only include labels 1252 for a smaller number of components. As a further alternative, a user may simply add labels 1252 for the items that they wish to include in the bill of materials.

Furthermore, FIG. 12B presents a bill of materials customization table 1254. This may permit the user to see the components that have been labelled in the cable illustration portion 1202 in a list, and the table 1254 may permit users to make changes in the description of each of the identified components. By listing out each of the labelled components, the bill of materials customization table 1254 allows the user to preview the final appearance of the bill of materials 1256 (see FIG. 12C).

In some embodiments, the bill of materials customization table 1254 may be presented simultaneously with the cable illustration portion 1202, enabling the user to better understand the bill of materials customization table 1254. This may reduce the number of errors and increase the accuracy of the final bill of materials. The first column may include buttons that may be selected to quickly identify for the user the relevant component in the cable illustration portion 1202. For example, where the first button shown for the “2 F, LC Uniboot SM Connector” is selected, the cable illustration portion 1202 may be shown with the representation of the connector emphasized. Additionally, the second column in the bill of materials customization table 1254 shows the designated label number for listed components, the third column shows the description for listed components, and the fourth column may reveal the quantity of each listed component. Another tab may be selected to input further notes regarding the user-customized cable, and these notes may be included in the final bill of materials in some embodiments.

FIG. 12C illustrates a final bill of materials 1256 that may be used. This may present the label number in the first column, the description in the second column, and the quantity in the third column. This final bill of materials 1256 may be presented alongside an image of the cable illustration portion 1202 illustrated in FIG. 12A. Furthermore, FIG. 12D may provide a table 1258 with other information regarding certain unique components within the user-customized cable such as the various connector types that are used. For example, the table 1258 may include the name of relevant connector types that are used as well as images showing the appearance of each connector type. This table 1258 may be provided alongside the final bill of materials 1256 and/or a drawing image of the user-customized cable in some embodiments.

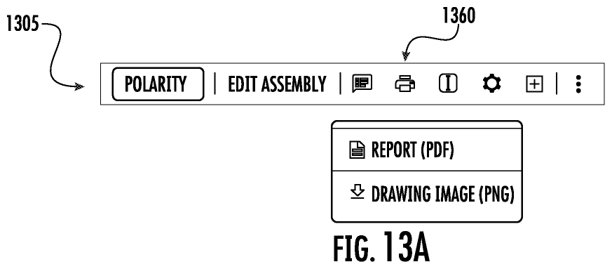

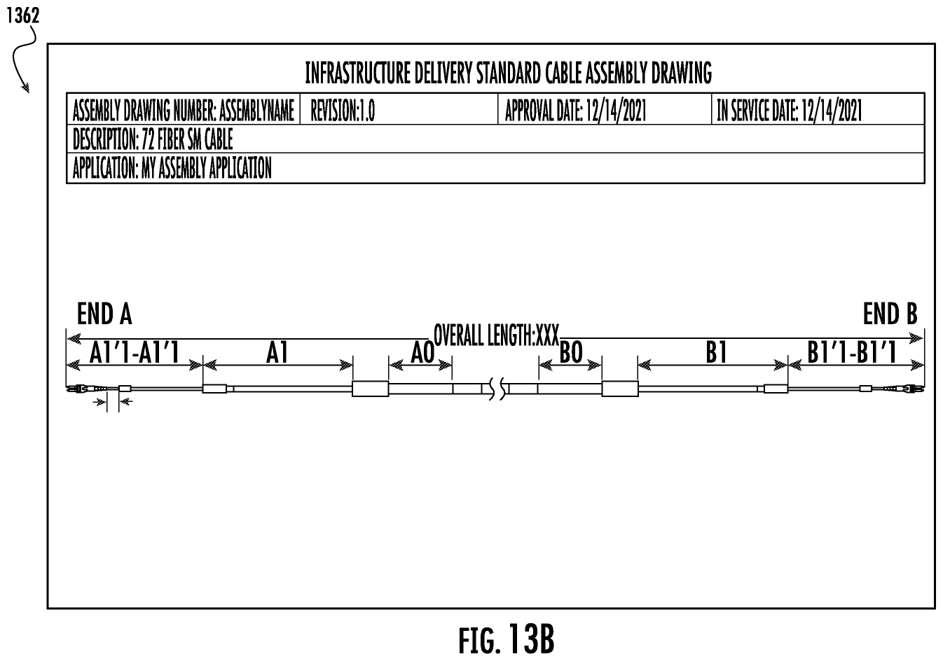

Drawing images may also be created of the user-customized cable in some embodiments, and an example of this is illustrated in FIG. 13B. FIG. 13B illustrates a drawing image 1362 of the user-customized cable illustrated in the cable illustration portion 202 of FIG. 2A. To generate this drawing image 1362, the user may select the print button 1360 (see FIG. 13A) on the selection menu 1305 (see FIG. 13A) and select the option to print the drawing image. The selection menu 1305 may also be used to navigate to other portions, windows, screens, etc. that are discussed herein.

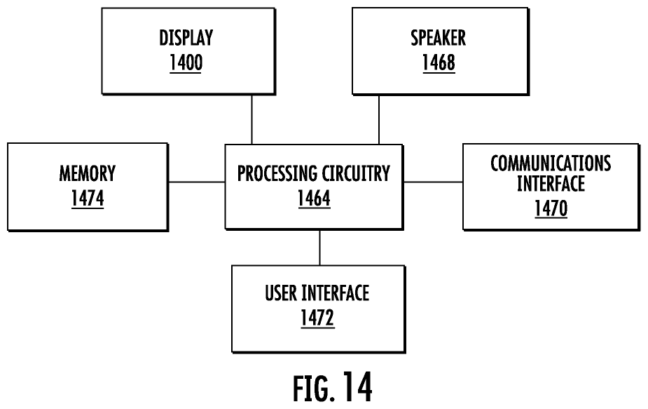

FIG. 14 is a block diagram illustrating various example components that may be used. For example, a system may include processing circuitry 1464. This processing circuitry 1464 may include one or more processors, microprocessors, controllers, microcontrollers, computers, servers, etc. Further, the processing circuitry 1464 may comprise components that are located at separate physical locations in some embodiments. The display 1400 may be similar to the display 100 of FIG. 1, and the display 1400 may be used to present various tables and other items. The display 1400 may be a touch screen in some embodiments, but the display 1400 may not be a touch screen in other embodiments. A speaker 1468 may be used in some embodiments to provide information via sound to the user. For example, the speaker 1468 may indicate that overutilization has occurred, that the number of end fibers on a first end of the user-customized cable does not match the number of end fibers on a second end, or to provide another notification. The speaker 1468 may be verbally communicate this information, or the speaker 1468 may instead make a buzzer noise to make relevant notifications. A communications interface 1470 may be used to permit the system to communicate with other external systems. For example, the communications interface 1470 may be used to send information to or receive information from an external server. A user interface 1472 may be provided as well, and the user interface 1472 may be used by the user to input information. The user interface 1472 may include directional arrows or other items that permit the user to select certain items presented on the display. Further, the user interface 1472 may include selection buttons and other buttons. The system may also include memory 1474, and computer-executable instructions may be provided in the memory 1474 that may ultimately be executed by the processing circuitry 1464. These computer-executable instructions may include code that causes the processing circuitry 1464 to perform various methods, including the methods that are described herein.

While the system illustrated in FIG. 14 shows each of the components connected to processing circuitry 1464, the items may be connected in other manners. Further, certain components may be added to the system, and components may also be omitted from the system.

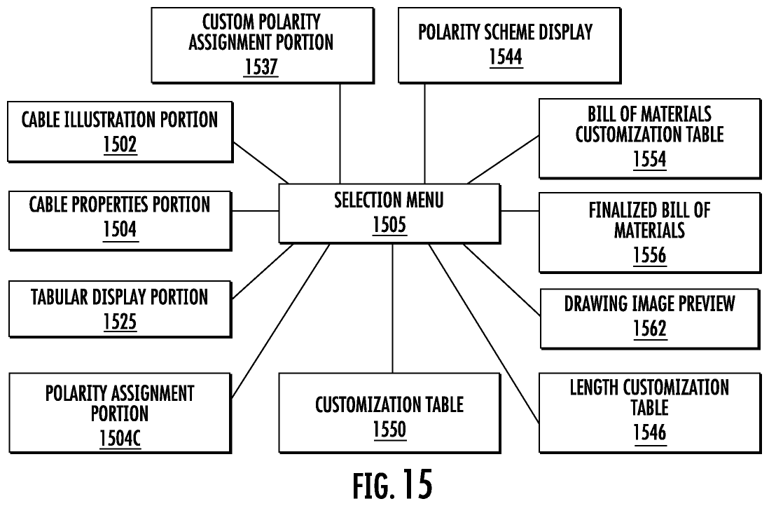

FIG. 15 is a block diagram illustrating various items that may be presented in a graphical user interface. A selection menu 1505 may be provided, and this selection menu 1505 (see FIG. 13A, 1305) may be used to navigate to other items of the graphical user interface. For example, in some embodiments, the selection menu 1505 may be used to navigate or cause the presentation of the cable illustration portion 1502 (see FIG. 1A), the cable properties portion 1504 (see FIG. 1A), the table display portion 1525 (see FIG. 4B), the polarity assignment portion 1504C (see FIG. 7A), the customization table 1550 (see FIG. 11B), the length customization table 1546 (see FIG. 11A), the drawing image preview 1562 (see FIG. 13B), the finalized bill of materials 1556 (see FIG. 12C), the bill of materials customization table 1554 (see FIG. 12B), the polarity scheme display 1544 (see FIG. 10A), and/or the custom polarity assignment portion 1537 (see FIG. 9A).

While the system illustrated in FIG. 15 shows that users may navigate from the selection menu to other various items, the user may be permitted to navigate directly between other items in some embodiments. For example, users may navigate directly between the cable illustration portion 1502 and the bill of materials customization table 1554 in some embodiments. Additionally, further items may be presented in the graphical user interface that are not depicted in FIG. 15, and certain items within the graphical user interface illustrated in FIG. 15 may be omitted in some embodiments.

Various methods are also contemplated herein, and some of these methods are related to performance of various methods described herein, such as may include the presentation of a graphical user interface on a display. FIG. 16 is a flow chart illustrating a method 1600 of presenting items in a graphical user interface. At operation 1602, the presentation of a graphical user interface may be caused to assist in the creation of a user-customized cable. The graphical user interface may include a cable illustration portion having a representation of a user-customized cable. The user-customized cable may include a primary cable and at least one subunit cable within the primary cable. The subunit cable may be a breakout cable within a primary cable, a leg cable within the breakout cable, or an additional cable within the leg cable. Additionally, each subunit cable may include at least one end fiber. The cable representation for the user-customized cable may be fit in the cable illustration portion to maximize the footprint of the cable representation in the cable illustration portion. The cable representation in the cable illustration portion may be presented based on relative lengths in some embodiments, and this may assist in maximizing the footprint of the cable representation in the cable illustration portion.

In addition to the cable illustration portion, the graphical user interface may also include a cable properties portion. The cable properties portion may be configured to permit a selection of a connector type, a number of breakout cables within a primary cable, a number of cable groups, or a number of connectors per cable group. However, other cable properties may be received at the cable properties portion in other embodiments. In some embodiments, the cable illustration portion and the cable properties portion may be presented simultaneously in a window.

A selection of a property for the user-customized cable may be received at operation 1604, and this selection may be received at the cable properties portion of the graphical user interface in some embodiments. The selected property may be the length of a cable within the user-customized cable (e.g. a primary cable, a breakout cable, a leg cable, etc.), the length of the user-customized cable as a whole, a stagger value causing cables within a same group to have varying lengths, a group offset value causing cables within a group to have lengths that are different than cables of another group, a jacket color of a cable (e.g. a primary cable, a breakout cable, a leg cable, etc.). At operation 1606, the cable representation of the user-customized cable may be altered in the cable illustration portion based on the selection made at operation 1604. In some embodiments, the alteration of the cable representation in the cable illustration portion based on the selection may be made automatically once the selection is made at operation 1604.

Furthermore, in some embodiments, presentation of a tabular display portion may also be caused at operation 1608. The tabular display portion may include a table with information about cables of the user-customized cable. For example, the table may include actual length information for cables represented in the cable illustration portion, color information for outer sheathing of cables in the user-customized cable, color information for labels, label text, or a polarity assignment for connectors associated with cables in the user-customized cable. Further, the table may include properties for cables at a first end of a cable representation for a user-customized cable while also including properties for cables at a second end of the cable representation, enabling the user to see corresponding properties for both ends of a cable representation at once to increase the ease of validation. However, other information may be presented in the table. The tabular display portion may be included in the graphical user interface in some embodiments. In some embodiments, the graphical user interface may present the cable illustration portion, the cable properties portion, and/or the tabular display portion simultaneously. Furthermore, the method 1600 may also include other operations, such as the presentation of additional items on the display.

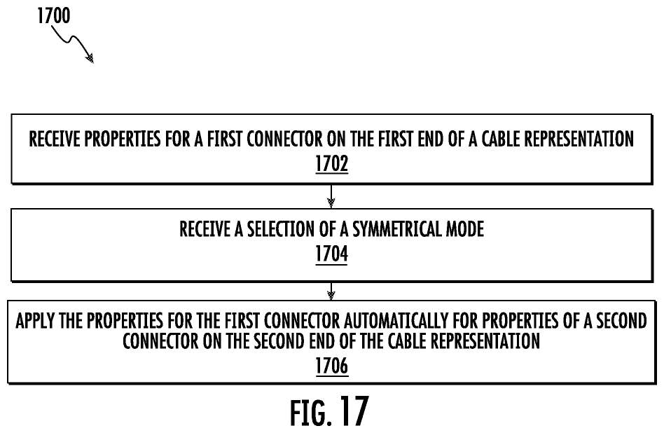

Methods are also contemplated for receiving input properties for cables of a user-customized cable. FIG. 17 is a flow chart illustrating one method 1700 of inputting properties for connectors or cables in a user-customized cable using a symmetrical mode. A first end of a cable representation for a user-customized cable may be provided on a first side of the cable illustration portion, and a second end of the cable representation for the user-customized cable may be provided on a second side of the cable illustration portion. At operation 1702, properties for a first connector on a first end of a cable representation for a user-customized cable may be received. At operation 1704, a selection of a symmetrical mode may be received. This may be received at an input field 106A within the cable properties portion 104 (see FIG. 1B). At operation 1706, properties received for the first connector may be applied automatically as the properties of a second connector, with the second connector being provided on a second end of the represented user-customized cable. Thus, the symmetrical mode may permit the user to input identical properties quickly and easily for cables on a first end and a second end of the user-customized cable.

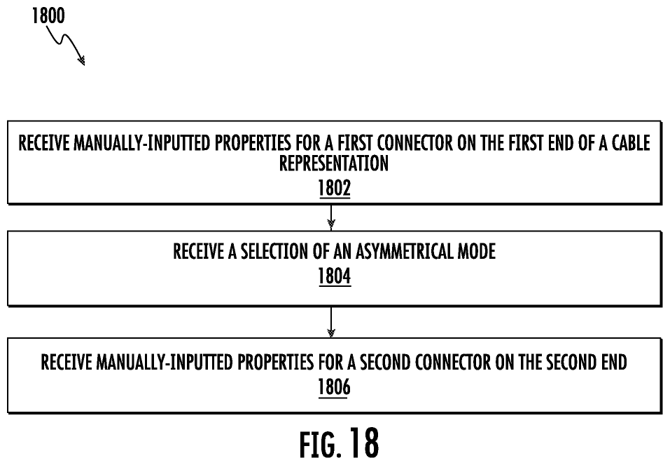

Other methods are also contemplated for the receipt of input properties in an asymmetrical mode. FIG. 18 is a flow chart illustrating one example method 1800 showing the potential operation in an asymmetrical mode. At operation 1802, manually-inputted properties may be received for a first connector. This first connector may be located at the first end of a cable representation for a user-customized cable. At operation 1804, a selection of an asymmetrical mode 1804 may be received. This may be received at an input field 106A within the cable properties portion 104 (see FIG. 1B). At operation 1806, manually-inputted properties may be received for a second connector. This second connector may be located at the second end of a cable representation for a user-customized cable.

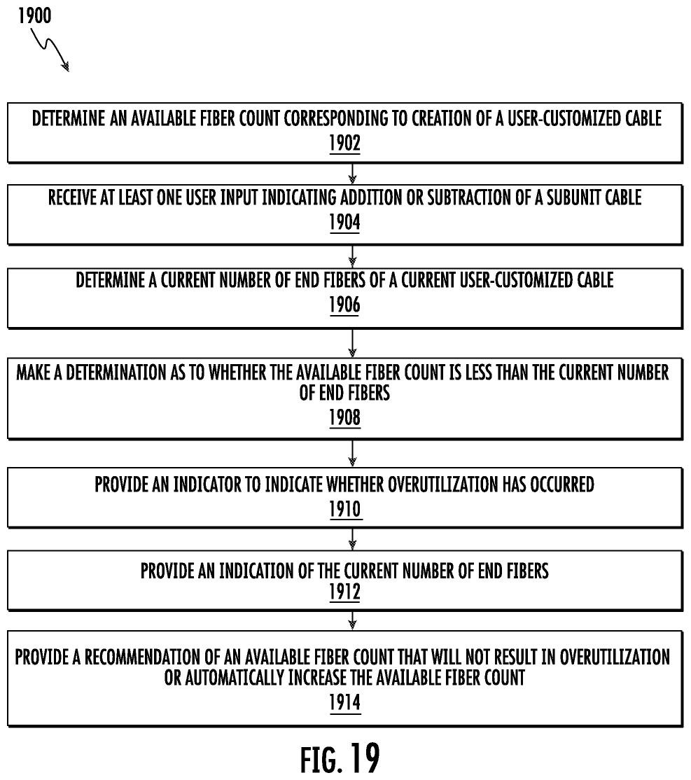

Various embodiments described herein track the utilization of available fibers in a user-customized cable, with some providing indications of whether an overutilization has occurred. FIG. 19 is a flow chart illustrating a method 1900 for indicating overutilization of available fibers within a user-customized cable.

At operation 1902, an available fiber count may be determined that corresponds to the creation of a user-customized cable. The available fiber count may be determined by receiving the available fiber count in some embodiments. The user-customized cable may include a primary cable and at least one subunit cable. The subunit cable may be any sized cable within the primary cable. For example, the subunit cable may be a breakout cable within the primary cable, a leg cable within the breakout cable, or an additional cable within the leg cable. However, only a primary cable, breakout cables, and leg cables are provided in some embodiments. Each subunit cable may include at least one end fiber. The available fiber count may be the theoretical number of end fibers available in the primary cable.

At operation 1904, at least one user input may be received indicating the addition or subtraction of the subunit cable. The input may cause the addition or subtraction of a subunit cable on only the first end or the second end of the user-customized cable in some embodiments, but the input may cause the addition or subtraction of a subunit cable on both of the first end and the second end of the user-customized cable in other embodiments.

At operation 1906, a current number of end fibers of a current user-customized cable may be determined. This current number of end fibers on each end of the user-customized cable may fluctuate based on the addition or subtraction of subunit cables at operation 1904. The current number of end fibers at a first end may be determined in some embodiments by adding up a number of end fibers in each of the leg cables on the first end of the user-customized cable together.

Additionally or alternatively, the current number of end fibers at a second end may be determined by adding up a number of end fibers in each of the leg cables on a second end of the user-customized cable together. For example, a first number of end fibers at a first end of the user-customized cable may be determined, and a second number of end fibers at a second end of the current user-customized cable may also be determined.

At operation 1908, a determination may be made as to whether the available fiber count is less than the current number of end fibers. In some embodiments, a specific determination may be made as to whether the available fiber count is equal to the current number of end fibers. In some embodiments, a specific determination may be made as to whether the available fiber count is greater than the current number of end fibers. These determinations may discover whether overutilization, underutilization, or full utilization has occurred.

Furthermore, determinations may be made as to whether overutilization has occurred at both the first end and the second end of the user-customized cable in some embodiments. For example, a first determination may be made as to whether the available fiber count is less than the first number of end fibers at the first end, and a second determination may be made as to whether the available fiber count is less than the second number of end fibers at the second end.

At operation 1910, an indicator may be provided to indicate whether or not overutilization has occurred, and this indicator may be based on the determination made at operation 1908. Where the determination at operation 1908 suggests that overutilization has occurred, the indicator may be an overutilization indication to indicate that the current user-customized cable overutilizes end fibers in some cases. Where the determination at operation 1908 suggests that overutilization has not occurred, the indicator may alternatively be an allowable utilization indication to indicate that the current user-customized cable underutilizes the end fibers or that the user-customized cable fully utilizes each of the end fibers without overutilization.

In some embodiments where a determination has been made that the available fiber count is greater than the current number of end fibers, a specific indication may be provided that the user-customized cable underutilizes the end fibers. Additionally, in some embodiments where a determination has been made that the available fiber count is equal to the current number of end fibers, an indication may be provided that the user-customized cable utilizes each of the end fibers without overutilization. Additionally, indications may be made based on determinations regarding overutilization at both ends of the user-customized cable.

The indicators discussed above regarding overutilization, underutilization, full utilization, etc. may be provided in a variety of ways. For example, the indicator may be provided by sending a signal having the indicator; by presenting the current number of end fibers on a display; by presenting a number of end fibers associated with a representation of a specific subunit cable; by presenting on the display a symbol that indicates the current number of end fibers; or by presenting an item in a first color on the display (e.g. through highlighting, changing color of text, etc.).

At operation 1912, an indication may be provided of the current number of end fibers. This indication may be provided for the current number of end fibers on a first end of the user-customized cable as well as the current number of end fibers on a second end of the user-customized cable in some embodiments.

The indication provided at operation 1912 with respect to the current number of end fibers may be provided in a variety of ways. For example, the indication may be provided by sending a signal having the indication of the current number of end fibers; presenting the current number of end fibers on a display; presenting a number of end fibers associated with a representation of a subunit cable on the display; presenting a symbol that indicates the current number of end fibers on the display; or presenting an item in a first color on the display (e.g. through highlighting, changing color of text, etc.).

Operation 1914 may be performed in instances where the determination of operation 1908 reveals that overutilization has occurred. At operation 1914, a recommendation of an available fiber count may be provided that may not result in overutilization. For example, if the available fiber count is initially set at a count of seventy two end fibers and if the current number of end fibers is between seventy three fibers and ninety six end fibers, the recommendation may suggest a new available fiber count of ninety six end fibers. The next available fiber count of ninety six end fibers is used here as an example, and other fiber counts may be made available (e.g. 80, 108, 144, 288, etc.). As an alternative to providing a recommendation, at operation 1914, the available fiber count may be increased automatically.

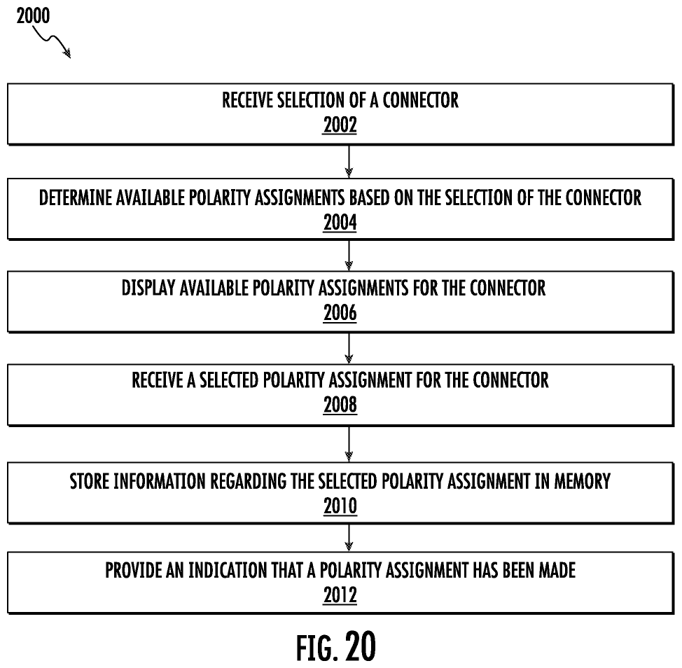

Methods are also contemplated for making polarity assignments for connectors, and FIG. 20 is a flow chart illustrating one method 2000 for making polarity assignments for connectors. At operation 2002, a selection of a connector may be received. The connector may be associated with a user-customized cable, and the user-customized cable may include a primary cable and at least one subunit cable within the primary cable. The subunit cable(s) may include the connector and at least one end fiber associated with the connector. In some embodiments, a selection of a plurality of connectors may be made rather than just a selection of one connector.

Available polarity assignments may be determined based on the selection of the connector(s) at operation 2004, and available polarity assignments may be displayed for the connector(s) at operation 2006. In some embodiments, two or more polarity assignments may be available. Available polarity assignments may include an A to A polarity, an A to B polarity, a new custom polarity, or a saved custom polarity in some embodiments.

A selected polarity assignment may be received for the connector(s) at operation 2008. Additionally, at operation 2010, information regarding the selected polarity assignment may be stored in memory. At operation 2012, an indication may be provided that a polarity assignment has been made for the connector(s). This indication may be provided by presenting the polarity assignment; presenting a color (e.g. through highlighting of a cable representation or a background, by changing text color); providing a notification; or ceasing emphasis of the connector and initiating emphasis of another connector. By ceasing emphasis of a connector and initiating emphasis of another connector, the user may be alerted that a polarity assignment has been successfully made for the connector.

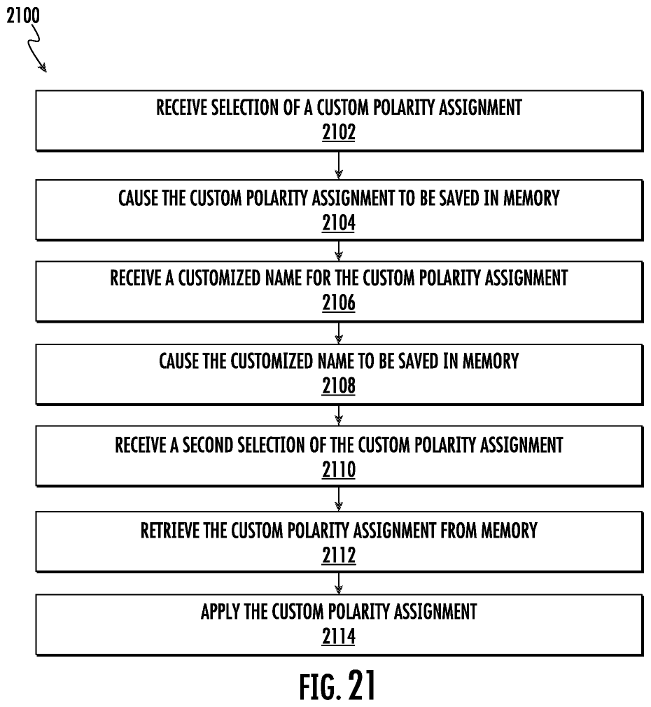

Custom polarity assignments may be used in various embodiments, and methods are contemplated for the creation of custom polarity assignments. FIG. 21 is a flow chart illustrating a method 2100 for making custom polarity assignments for connectors.

At operation 2102, a selection of a custom polarity assignment may be received. At operation 2104, the item performing the method 2100 may cause the selected custom polarity assignment to be saved in memory. Additionally, a customized name may be received for the custom polarity assignment at operation 2106, and the item performing the method 2100 may cause the customized name to be saved in memory at operation 2108. This customized name may be saved together with the custom polarity assignment, and the customized name may be associated with the custom polarity assignment in memory.

Once the custom polarity assignment has been saved in memory, this custom polarity assignment may be reselected, retrieved, and applied. For example, at operation 2110, a second selection may be received of the custom polarity assignment. The custom polarity assignment may be retrieved from memory at operation 2112, and the custom polarity assignment may be applied at operation 2114.

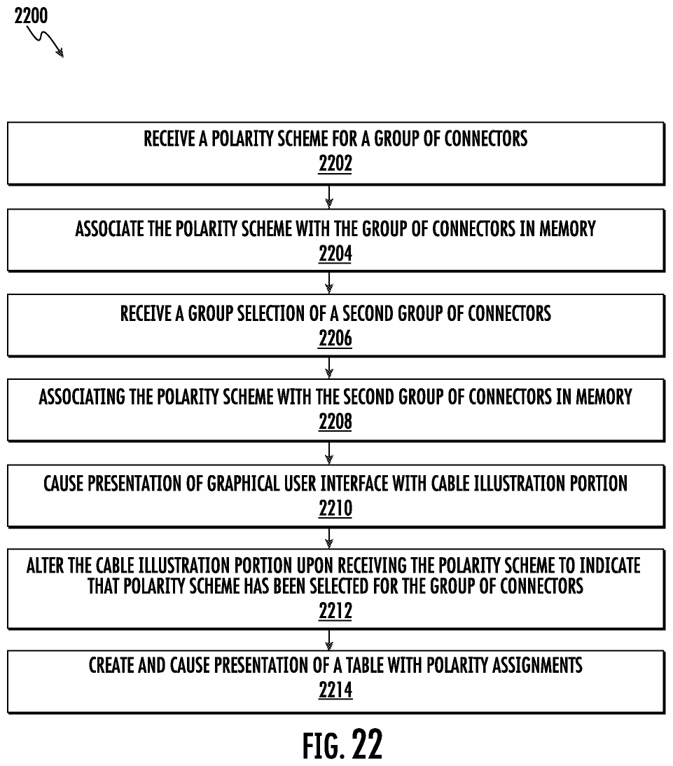

Some embodiments permit the selection of a polarity scheme for a group of connectors at a single time, and this polarity scheme may be saved in memory so that it may be reapplied for other groups of connectors. FIG. 22 is a flow chart illustrating one method 2200 for inputting polarity schemes for multiple groups of connectors.

At operation 2202, a polarity scheme for a group of connectors may be received, and the polarity scheme may be associated with the group of connectors in memory at operation 2204. In some embodiments, the polarity scheme may be a uniform polarity scheme where each connector in the group of connectors has the same polarity assignment. However, in other embodiments, the polarity scheme may be a non-uniform polarity scheme where connectors in the group of connectors do not all have the same polarity assignment. A group selection of a second group of connectors may be received at operation 2206, and the polarity scheme may be associated with the second group of connectors in memory at operation 2208.

At operation 2210, the presentation of a graphical user interface with a cable illustration portion may be caused. The cable illustration portion may include cable representations for a user-customized cable. At operation 2212, the cable illustration portion may be altered upon receiving the polarity scheme to indicate that the polarity scheme has been selected for the group of connectors.

At operation 2214, the item performing the method 2200 may create a table with polarity assignments and cause the presentation of the table. The table may include color information for connectors on a first end of the user-customized cable as well as color information for connectors on a second end of the user-customized cable.

Additionally or alternatively, the table may include information regarding polarity assignments for at least one connector on a first end of the user-customized cable, and the table may also include information regarding polarity assignments for at least one connector on a second side of the user-customized cable.

Additionally or alternatively, the table may include a first set of cable properties for a first end of the user-customized cable, and the table may also include a second set of cable properties for a second end of the user-customized cable. The first set of cable properties and the second set of cable properties may be provided adjacent to each other. The placement of the first set and the second set adjacent to each other may help permit the user to easily validate fiber mapping from the first end of the user-customized cable to the second end of the user-customized cable.

Furthermore, in some embodiments, polarity schemes may be created for a group of connectors, and processing circuitry or another item may identify patterns within the polarity assignments made for the group of connectors. Processing circuitry may subsequently make polarity assignments for other connectors based on the identified pattern.

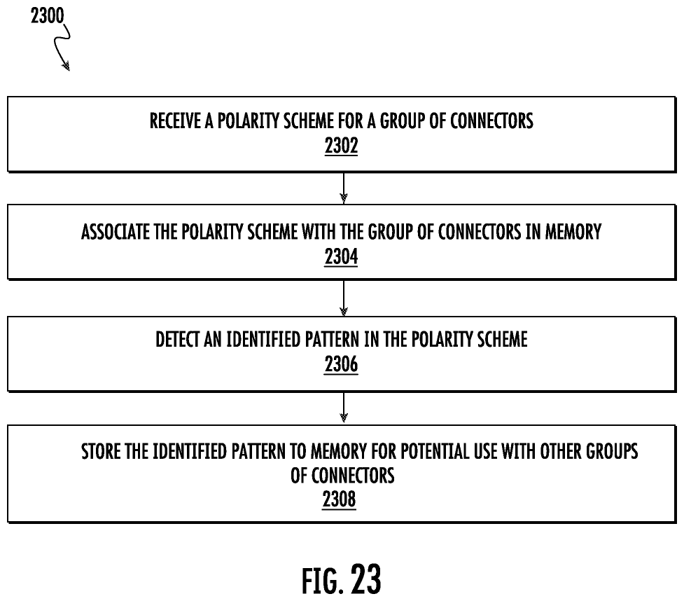

FIG. 23 is a flow chart illustrating an example method 2300 for setting a polarity scheme based on identified patterns. A polarity scheme may be received for a group of connectors at operation 2302, and the polarity scheme may be associated with the group of connectors in memory at operation 2304. At operation 2306, an identified pattern may be detected in the polarity scheme. The identified pattern may be stored to the memory for potential use with other groups of connectors at operation 2308. The ability to identify patterns in polarity schemes may be useful so that the pattern may be applied with other groups of connectors. For example, if a group of six connectors has two different polarity assignments used in an alternating fashion, the alternating pattern may be identified and applied for a group of four connectors.

The operations discussed herein for the methods illustrated in FIGS. 16-23 may be performed in any order unless otherwise noted or unless readily apparent, and some operations may be performed simultaneously in some embodiments. For example, operation 2104 and operation 2108 of the method 2100 illustrated in FIG. 21 may be performed simultaneously in some embodiments so that the custom polarity assignment and customized name are simultaneously saved in memory. Additionally, certain operations may be omitted from the methods of FIGS. 16-23, or other additional operations may be added to the methods of FIGS. 16-23. Methods discussed herein may be performed by a variety of components, including but not limited to a processor, a microprocessor, a controller, a microcontroller, a computer, or a server.

It will therefore be readily understood by those persons skilled in the art that the present invention is susceptible of broad utility and application. Many embodiments and adaptations of the present invention other than those herein described, as well as many variations, modifications, and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications, and equivalent arrangements.

1. A non-transitory computer readable medium having stored thereon a plurality of computer-executable instructions which, when executed by processing circuitry, cause the processing circuitry to:
determine an available fiber count corresponding to creation of a user-customized cable, wherein the user-customized cable includes a primary cable and at least one subunit cable, wherein the at least one subunit cable includes at least one end fiber, wherein the available fiber count is a theoretical number of end fibers available in the primary cable;
receive at least one user input indicating addition or subtraction of a subunit cable on at least one of a first end of the user-customized cable or a second end of the user-customized cable;
determine a current number of end fibers of the user-customized cable;
make a determination as to whether the available fiber count is less than the current number of end fibers; and
provide, based on the determination, an indicator comprising:
an overutilization indication to indicate that the user-customized cable overutilizes end fibers; or
an allowable utilization indication to indicate that the user-customized cable underutilizes the end fibers or utilizes each of the end fibers without overutilization.

2. The non-transitory computer readable medium of claim 1, wherein the plurality of computer-executable instructions are configured to cause the processing circuitry to:
provide the overutilization indication to indicate that the user-customized cable overutilizes the end fibers, when the determination returns that the available fiber count is less than the current number of end fibers.

3. The non-transitory computer readable medium of claim 1, wherein the plurality of computer-executable instructions are configured to cause the processing circuitry to:
provide the allowable utilization indication to indicate that the user-customized cable underutilizes the end fibers or utilizes each of the end fibers without overutilization, when the determination returns that the available fiber count is not less than the current number of end fibers.

4. The non-transitory computer readable medium of claim 1, wherein the plurality of computer-executable instructions are configured to cause the processing circuitry to:
provide an indication that the user-customized cable underutilizes the end fibers, when the determination returns that the available fiber count is greater than the number of end fibers.

5. The non-transitory computer readable medium of claim 1, wherein the plurality of computer-executable instructions are configured to cause the processing circuitry to:
provide an indication that the user-customized cable utilizes each of the end fibers without overutilization when the determination returns that the available fiber count is equal to the current number of end fibers.

6. The non-transitory computer readable medium of claim 1, wherein the plurality of computer-executable instructions are configured to cause the processing circuitry to:
provide the indicator by performing at least one of:
sending a signal having the indicator;
presenting on a display the current number of end fibers;
presenting on the display a number of end fibers associated with a representation of a subunit cable;
presenting on the display a symbol that indicates the current number of end fibers; or
presenting on the display an item in a first color.

7. The non-transitory computer readable medium of claim 1, wherein the plurality of computer-executable instructions are configured to cause the processing circuitry to:
provide an indication of the current number of end fibers.

8. The non-transitory computer readable medium of claim 7, wherein the plurality of computer-executable instructions are configured to cause the processing circuitry to:
provide the indication of the current number of end fibers by performing at least one of:
sending a signal having the indication of the current number of end fibers;
presenting on a display the current number of end fibers;
presenting on the display a number of end fibers associated with a representation of a subunit cable;
presenting on the display a symbol that indicates the current number of end fibers; or
presenting on the display an item in a first color.

9. The non-transitory computer readable medium of claim 7, wherein the plurality of computer-executable instructions are configured to cause the processing circuitry to:
provide an indication of a current number of end fibers for the first end of the user-customized cable; and
provide an indication of a current number of end fibers for the second end of the user-customized cable.

10. The non-transitory computer readable medium of claim 1, wherein the plurality of computer-executable instructions are configured to cause the processing circuitry to:
provide a recommendation indication of a new available fiber count for the primary cable that does not result in overutilization, when the determination returns that the available fiber count is less than the current number of end fibers.

11. The non-transitory computer readable medium of claim 10, wherein the available fiber count is initially set at a count of seventy two end fibers, wherein the new available fiber count is set at a count of ninety six end fibers when the current number of end fibers is between seventy three end fibers and ninety six end fibers.

12. The non-transitory computer readable medium of claim 1, wherein the plurality of computer-executable instructions are configured to cause the processing circuitry to:
increase the available fiber count automatically when the determination returns that the available fiber count is less than the current number of end fibers.

13. The non-transitory computer readable medium of claim 1, wherein the at least one subunit cable includes a breakout cable and at least one leg cable within the breakout cable, wherein each leg cable of the at least one leg cable includes a plurality of end fibers therein, wherein the current number of end fibers at the first end of the user-customized cable is determined by adding a number of end fibers in each leg cable on the first end of the user-customized cable together.

14. The non-transitory computer readable medium of claim 1, wherein the plurality of computer-executable instructions are configured to cause the processing circuitry to:
determine a first number of end fibers at the first end of the user-customized cable;
determine a second number of end fibers at the second end of the user-customized cable;
make a first determination as to whether the available fiber count is less than the first number of end fibers;
make a second determination as to whether the available fiber count is less than the second number of end fibers; and
provide, based on the first determination and the second determination, the indicator comprising:
the overutilization indication to indicate that the user-customized cable overutilizes the end fibers; or
the allowable utilization indication that the user-customized cable underutilizes the end fibers or utilizes each of the end fibers without overutilization.

15. A method for indicating whether a user-customized cable overutilizes end fibers, the method comprising:
determining an available fiber count corresponding to creation of the user-customized cable, wherein the user-customized cable includes a primary cable and at least one subunit cable, wherein the at least one subunit cable includes at least one end fiber, wherein the available fiber count is a theoretical number of end fibers available in the primary cable;
receiving at least one user input indicating addition or subtraction of a subunit cable on at least one of a first end of the user-customized cable or a second end of the user-customized cable, wherein the subunit cable includes one or more end fibers;
determining a current number of end fibers of the user-customized cable;
making a determination as to whether the available fiber count is less than the current number of end fibers; and
providing, based on the determination, an indicator comprising:
an overutilization indication to indicate that the user-customized cable overutilizes end fibers; or
an allowable utilization indication that the user-customized cable underutilizes the end fibers or utilizes each of the end fibers without overutilization.

16. The method of claim 15, further comprising
providing the overutilization indication to indicate that the user-customized cable overutilizes the end fibers, when the determination returns that the available fiber count is less than the current number of end fibers.

17. The method of claim 15, further comprising:
providing the indicator by performing at least one of:
sending a signal having the indicator;
presenting on a display the current number of end fibers;
presenting on the display a number of end fibers associated with a representation of a subunit cable;
presenting on the display a symbol that indicates the current number of end fibers; or
presenting on the display an item in a first color.

18. The method of claim 15, further comprising:
providing an indication of the current number of end fibers.

19. The method of claim 18, further comprising:
providing the indication of the current number of end fibers by performing at least one of:
sending a signal having the indication of the current number of end fibers;
presenting on a display the current number of end fibers;
presenting on the display a number of end fibers associated with a representation of a subunit cable;
presenting on the display a symbol that indicates the current number of end fibers; or
presenting on the display an item in a first color.

20. The method of claim 18, further comprising
providing an indication of a current number of end fibers for the first end of the user-customized cable; and
providing an indication of a current number of end fibers for the second end of the user-customized cable.

21. The method of claim 15,
wherein determining the current number of end fibers in the user-customized cable involves determining a first number of end fibers in the user-customized cable at the first end of the user-customized cable and determining a second number of end fibers in the user-customized cable at the second end of the user-customized cable,
wherein making the determination as to whether the available fiber count is less than the current number of end fibers involves making a first determination as to whether the available fiber count is less than the first number of end fibers and making a second determination as to whether the available fiber count is less than the second number of end fibers,
further comprising providing, based on the first determination and the second determination, the indicator selected from a group consisting of:
the overutilization indication to indicate that the user-customized cable overutilizes the end fibers; or
the allowable utilization indication that the user-customized cable underutilizes the end fibers or utilizes each of the end fibers without overutilization.

22. A graphical user interface for creation of a user-customized cable, the graphical user interface comprising:
a cable illustration portion including a cable representation, wherein the cable representation includes a representation of the user-customized cable; and
an indication portion,
wherein the graphical user interface is configured to:
determine an available fiber count corresponding to the creation of the user-customized cable, wherein the user-customized cable includes a primary cable and at least one subunit cable, wherein the at least one subunit cable includes at least one end fiber, wherein the available fiber count is a theoretical number of end fibers available in the primary cable;
receive at least one user input indicating addition or subtraction of a subunit cable on at least one of a first end of the user-customized cable or a second end of the user-customized cable;
determine a current number of end fibers of the user-customized cable;
make a determination as to whether the available fiber count is less than the current number of end fibers; and
provide, based on the determination, an indicator within the indication portion comprising:
an overutilization indication to indicate that the user-customized cable overutilizes end fibers; or
an allowable utilization indication that the user-customized cable underutilizes the end fibers or utilizes each of the end fibers without overutilization.
